(19) United States
(12) Patent Application Publication
(10) Pub. No.: US 2024/0362454 A1
(43) Pub. Date: Oct. 31, 2024

(54) SYSTEMS AND METHODS OF MACHINE LEARNING-BASED PHYSICAL SAMPLE CLASSIFICATION WITH SAMPLE VARIATION CONTROL

(71) Applicant: ThinkCyte K.K., Tokyo (JP)

(72) Inventors: Hirofumi Nakayama, Tokyo (JP); Ryo Tamoto, Tokyo (JP)

(73) Assignee: ThinkCyte K.K., Tokyo (JP)

(21) Appl. No.: 18/648,220

(22) Filed: Apr. 26, 2024

Related U.S. Application Data
(60) Provisional application No. 63/462,724, filed on Apr. 28, 2023.

(51) Int. Cl. G06N 3/042

(52) U.S. Cl. CPC G06N 3/042

(57) ABSTRACT

Systems and methods are provided to implement classification of objects, based on sensor data regarding the objects, in a manner that addresses variations in the sensor data, including measurement variables among the objects. A system can include one or more processors to retrieve sensor data regarding an object that is at least one of cellular material from one or more cells, nucleic acid material, biological material, or chemical material. The one or more processors can apply the sensor data as input to a classifier to cause the classifier to determine a classification of the object, the classifier configured based on feature data from a first example of object data and a second example of object data associated with at least one of a different time of detection or a different subject than the first example.

### CROSS-REFERENCE TO RELATED APPLICATIONS

The present application claims the benefit of and priority to U.S. Provisional Application No. 63/462,724, filed Apr. 28, 2023, the disclosure of which is incorporated herein by reference in its entirety.

### FIELD

This application relates generally to the field of machine learning-based classifiers, and more particularly to machine learning-based physical sample classifiers.

### BACKGROUND

Classification models can be used to assign class information to samples, such as class information indicative of one or more characteristics or identifiers of samples. Class information can be assigned based on processing of sensor data regarding the samples.

### SUMMARY

The performance of classification models can be limited by the quality of the training data used to configure the classification models. The present disclosure addresses this and other aspects.

At least one aspect relates to a system. The system can include one or more processors. The one or more processors can retrieve sensor data regarding an object. The object can include at least one biological sample or portion thereof. The biological sample can be or include at least one of cellular material from one or more cells, nucleic acid material, biological material, chemical material or any combination thereof. The one or more processors can apply the sensor data as an input to a classifier to cause the classifier to determine a classification of the object. The classifier can be configured based on feature data from at least a first example of object data and a second example of object data, the second example being associated with at least one of a different time of detection or a different subject than the first example. The one or more processors can output the classification of the object.

At least one aspect relates to a system. The system can include a flow cytometer configured to direct a fluid flow including an object through a field of view of a photosensor/photodetector, and to cause the photosensor/photodetector to detect sensor data regarding the object. The system can include one or more processors. The one or more processors can apply the sensor data as an input to a classifier to cause the classifier to determine a classification of the object. The classifier can be configured based on feature data from at least a first example of object data and a second example of object data, the second example being associated with at least one of a different time of detection or a different subject than the first example.

At least one aspect relates to a method. The method can include receiving, by one or more processors, a plurality of waveforms, each waveform being representative of an object type of a corresponding object of a plurality of objects, a first waveform of the plurality of waveforms associated with at least one of a different time of detection or a different subject than a second waveform of the plurality of waveforms. The plurality of objects can include at least one of cellular material from one or more cells, nucleic acid material, biological material, or any combination thereof. The method can include detecting, by the one or more processors, one or more features based on the plurality of waveforms, the one or more features satisfying at least one of a reproducibility criterion or a differentiation criterion amongst the plurality of waveforms. The method can include updating, by the one or more processors, a machine learning model based on the detected one or more features to configure the machine learning model as a classifier for detection of object types.

At least one aspect relates to a method. The method can include illuminating observed objects by light with an illumination pattern over a time period. The method can include receiving, by a sensor, electromagnetic waves irradiated from the observed objects illuminated by the illumination pattern. The method can include converting the electromagnetic waves into time-series electrical signals. The method can include analyzing the time-series electrical signals converted from the electromagnetic waves to classify target objects among the observed objects. The analyzing step can include (a) feeding the time-series electrical signals into a supervised classification algorithm to extract at least one feature, (b) feeding the at least one feature extracted in (a) into a dimensionality reduction method to set at least one gate to predict a class of the observed objects, (c) performing machine learning to create a classification model using the time-series electrical signals, wherein the time-series electrical signals of the target objects are differentiated by the gate set in (b) among the time-series electrical signals of the observed objects, and (d) classifying the target objects among the observed objects using the time-series electrical signals of the observed objects based on the classification model.

At least one aspect relates to a method. The method can include illuminating observed objects by light with an illumination pattern over a time period. The method can include receiving by sensor electromagnetic waves irradiated from the observed objects illuminated by the illumination pattern. The method can include converting the electromagnetic waves into time-series electrical signals. The method can include analyzing the time-series electrical signals converted from the electromagnetic waves to classify target objects among the observed objects. The analyzing step can include (a) feeding the time-series electrical signals into a supervised classification algorithm to predict a class for each of the observed objects, (b) differentiating the time-series electrical signals of the target objects based on the class of the observed objects set in (a); (c) performing machine learning to create a classification model using the time-series electrical signals, wherein the time-series electrical signals of the target objects are differentiated by the predicted class set in (b) among the time-series electrical signals of the observed objects; and (d) classifying the target objects among the observed objects using the time-series electrical signals of the observed objects based on the classification model.

In some implementations, the supervised classification algorithm used to extract at least a feature in (a) is a neural network or a gradient-boosted decision tree (GBDT). In some implementations, wherein the dimensionality reduction method is used to find at least one distinguishable characteristic, the dimensionality reduction method is one of an autoencoder, Uniform Manifold Approximation and Projection (UMAP), principal component analysis (PCA), or t-distributed Stochastic Neighbor Embedding (t-SNE) technique. In some implementations, the classification model created by performing machine learning is created using one or more of a support vector machine (SVM), logistic regression, or a decision tree. In some implementations, the method includes sorting the target objects among the observed objects after analyzing the time-series electrical signals.

At least one aspect relates to a method. The method can include illuminating observed objects by light (i.e., light from a light source) with an illumination pattern over a time period (e.g., a structured illumination pattern). The method can include receiving, by a sensor, electromagnetic waves irradiated from the observed objects illuminated by the illumination pattern. The method can include converting the electromagnetic waves into time-series electrical signals. The method can include analyzing the time-series electrical signals converted from the electromagnetic waves to classify target objects among the observed objects. The method can include sorting the target objects among the observed objects without generation of an image. The analyzing step can include (a) feeding (i.e., inputting) the time-series electrical signals into a neural network to extract at least one feature; (b) feeding the at least one feature extracted in (a) into a UMAP to set at least one gate to predict a class of the observed objects; (c) performing machine learning to create a classification model using the time-series electrical signals, wherein the time-series electrical signals of the target objects are differentiated by the gate set in (b) among the time-series electrical signals of the observed objects; and (d) classifying the target objects among the observed objects using the time-series electrical signals of the observed objects based on the classification model.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example of a sensor system to perform classification of objects.

FIG. 2 depicts an example of a flow cytometer to detect information regarding objects.

FIG. 3 depicts an example of a training system to train a classification model for classification of objects.

FIG. 4 depicts an example of a process for training a classification model using dimensionality reduction.

FIG. 5 depicts an example of a process for training a classification model using clustering.

FIG. 6 depicts an example of a process for training a classification model using feature extraction.

FIG. 7 depicts an example of a process for training a classification model using class prediction.

FIGS. 8A, 8B and 8C depict example charts of performance of a classification model for object sorting.

FIGS. 9A, 9B, 9C, 9D and 9E depict example charts of performance of a classification model for blood cell sorting.

FIGS. 10A, 10B, 10C, 10D and 10E depict example charts of performance of a classification model for donor cell sample sorting.

FIGS. 11A, 11B, 11C, 11D, 11E, 11F, 11G, 11H and 11I depict example charts showing reproducibility of features extracted from sensor data in UMAP spaces.

FIG. 12 depicts examples of UMAP charts showing prediction of unknown classifications.

FIGS. 13A and 13B depict example charts of performance of a classification model for cell sample sorting.

FIG. 14 depicts an example of a method for training a classification model for object classification.

FIG. 15 depicts an example of a method for deploying a classification model for object classification.

FIG. 16 depicts an example of a label-free cellular sorter utilizing ghost cytometry.

FIG. 17 shows an example of computer system that is programmed or otherwise configured to implement methods and systems of the present disclosure.

### DETAILED DESCRIPTION

Following below are more detailed descriptions of various concepts related to, and implementations of systems and methods of machine learning-based physical sample classifiers (e.g., biological, and/or chemical sample classifiers), including machine-learning based sample classifiers with sample variation control. While various implementations described herein relate to configuring classifiers for processing cell data from flow cytometers, the system and methods described herein can be implemented for any of various classifiers. In particular, the classifiers can relate to, but are not limited to, classifiers for cellular material from one or more cells, protein material, DNA material, RNA material, biological material, chemical material, or any combination thereof. The cellular material can include material from one or more cells from a population of cells, including peptides, polypeptides or proteins, for example.

Classifiers, including machine learning-based classification models, are useful for detecting useful information regarding objects, such as samples of materials, such as samples of cells, biological materials, and/or chemical materials. For example, classification models can be used to detect class information such as types of cells and/or features of cells. The classification models can be trained by being provided training data that includes data regarding the objects (e.g., sensor data) and labels corresponding to the class information. Examples of classification are set forth in U.S. Pat. No. 11,314,994, issued on Apr. 26, 2022, and U.S. Patent Application Publication No. 2022/0317020, published Jan. 18, 2024, the entire contents of each of which are incorporated herein by reference, including for the classification target techniques set forth therein.

For example, some classification models rely on artificial labelling such as molecular marker tagging and/or staining of samples, which can then be detected by sensor systems (e.g., flow cytometers) and/or from processing of outputs from the sensors. The sensor outputs can thus be used for training of the classification models, where the molecular markers can act as labels for the sensor outputs that the classification models can use for learning to classify the samples. Examples of learning are set forth in U.S. Patent Application Publication No. 2020/0027020, published Jan. 23, 2020, and U.S. Pat. No. 11,643,649, issued on May 9, 2023, the entire contents of each of which are incorporated herein by reference, including for the learning techniques set forth therein.

However, reliance on labeling can increase the material and/or data requirements for training the classification models, such as by requiring the use of molecular markers and/or sufficient amounts of the target objects to be classified. In addition, the use of molecular markers for training can limit the ability of the classification models to effectively classify objects and/or detect classes of objects that are not directly associated with the information represented by the molecular markers. For example, cells can have unknown molecular markers and/or the molecular markers for a given cell or subset of cells may not be specific enough to effectively train classification models. As such, it can be difficult to create a classification model which can precisely predict a specific cell type (target cell) among other cell types in the test sample if the target cells cannot be tagged with known molecular marker. Such factors can similarly make it challenging for creating classification models for physical sample classification, such as for various chemical and/or biological samples.

The manner in which the outputs of the sensors represent characteristics of the objects can be susceptible to variations (e.g., and without limitation, idiosyncratic differences) over different samples from the same subject (or different subjects) and/or over time, even where such samples have identical characteristics. For example, when outputs (including but not limited to outputs of a flow cytometer) are collected over an extended period of time, they can exhibit different patterns (e.g., waveform patterns), even for biological replicates and/or from the same cell. Such variations can result for a variety of factors, including but not limited to instrument fluctuation, biological variability, or measurement conditions. Such variations can make it challenging to address by direct calibration for such factors (e.g., by only calibrating based on a measurement condition such as ambient temperature). Machine learning-based classification models may in turn incorrectly classify the samples as being of different types or may fail to detect a class for a sample with sufficient confidence, or otherwise have lower performance due to the variations in the underlying data. Similarly, training machine learning models using such outputs can result in lower performance models.

Systems and methods in accordance with the present disclosure can facilitate training and operation of classification models in a manner that controls for variations in sensor data that would otherwise represent similar or identical samples (e.g., biological replicates). For example, the classification models can be trained based on training data representing features that satisfy reproducibility (e.g., features that are reproducible over subjects and/or time) and/or differentiation (e.g., features that distinguish classes, such as cell types) criteria. The classification models can be trained based on processing of the training data by at least one variation controller (e.g., a neural network or other machine learning model implemented as the variation controller). The variation controller can detect features (e.g., for downstream clustering and/or dimensionality reduction prior to configuration of a classification model) and/or class information (for configuration of the classification model) that meet the criteria. As such, systems and methods in accordance with the present disclosure can train and operate classification models that can control for variations in sensor data. For example, the classification models can be trained to permit detection of unknown classifications (e.g., via achieving greater confidence in detecting classifications not present in the data used to train the classification model, rather than such unknown classifications corresponding to measurement variability).

Systems and methods in accordance with the present disclosure can facilitate training and operation of classification models with reduced use or without use of labeling corresponding to the classes. For example, the classification model can be trained without providing artificial labels to the objects (e.g., cells), which can reduce the requirements for training of the models and make the models for effective for predicting classes beyond those directly related to label information. This can include training the classification model based on clusters and/or gates detected from dimensionality reduction of unlabeled data. The classification model can in turn be used for classifying and sorting of target objects amongst observed objects. The classification model can be implemented for real-time (or near real-time operation) on sensor data, which can facilitate high throughput processing of sensor data, e.g., high throughput classification of objects. The classification model can be implemented on a field-programmable gate array (FGPA) hardware device to facilitate effective real-time operation.

For example, time-series electrical signals obtained from electromagnetic waves, such as waveforms obtained without image production from the waveforms (e.g., ghost motion imaging (GMI) waveforms obtained by ghost cytometry) can be applied to at least one unsupervised machine learning model, based on which the least one unsupervised machine learning model can set at least one gate or cluster to differentiate the time-series electrical signals of a subset of observed cells among the time-series electrical signals obtained from the observed cells. Ghost cytometry can be used to produce an image of an object without a spatially resolving detector. In particular, ghost cytometry can be performed to achieve cell classification and/or selective sorting based on cell morphology without reliance on a specific biomarker. Examples of ghost cytometry are set forth, e.g., in U.S. Pat. No. 11,788,948, issued on Oct. 17, 2023, the entire contents of which are incorporated herein by reference, including for the ghost cytometry systems and methods set forth therein. Further, examples of electromagnetic wave generation are found, for example, in U.S. Pat. No. 10,904,415 issued on Jan. 26, 2021, and U.S. Pat. No. 11,549,880, issued on Jan. 10, 2023, the entire contents of each of which are incorporated herein by reference, including for the electromagnetic wave generation and imaging techniques therein. Thereafter, the time-series electrical signals of the target cells obtained from the test sample can be digitally differentiated using the at least one gate or one cluster for the prediction of a target cells among the observed cells. Further, learning of a classification model is performed using the digitally differentiated time-series electrical signals as a set of training data without giving artificial labeling to the observed cells. As such, the classification model can accurately predict a specific cell type (e.g., target cells) among other cell types in the test sample in the case that the target cells cannot be obtained in a sufficient quantity for the training of the classification model. The classification model can predict target cells among other cells in the test sample even in the case that no molecular marker of the target cells is identified for isolating the cells.

In some implementations, a system includes one or more processors, which can be at least partially implemented by hardware, such as a flow cytometer, or can be communicably coupled with the sensor. The one or more processors can retrieve sensor data regarding an object. The object can include a cell, a biological sample, a chemical sample, or various combinations thereof. The sensor data can be from a flow cytometer. For example, the sensor data can include or be representative of a waveform, such as a time-series electrical signal representative of an electromagnetic wave detected regarding the object. In particular, the electrical signal is representative of an electromagnetic wave corresponding to the object or objects (e.g., cellular material as described above). The one or more processors can apply the sensor data as input to a classifier to cause the classifier to determine a classification of the object. The classification model can be configured based on feature data from at least a first example of object data and a second example of object data, the second example associated with at least one of a different time of detection or a different subject than the first example. The one or more processors output the classification, such as to output the classification as a cell type of a cell. By incorporating various features described herein, systems and methods in accordance with the present disclosure can achieve higher performance in the classification of objects such as cellular material, nucleic acid material, biological samples, chemical samples, or various combinations thereof. For example, the classification models can be capable of accurately aligning data across multiple donors, cellular populations, and/or measurements. Further, the classification models are scalable across many classifications, including among different cell types.

### Sensors for Object Data Detection

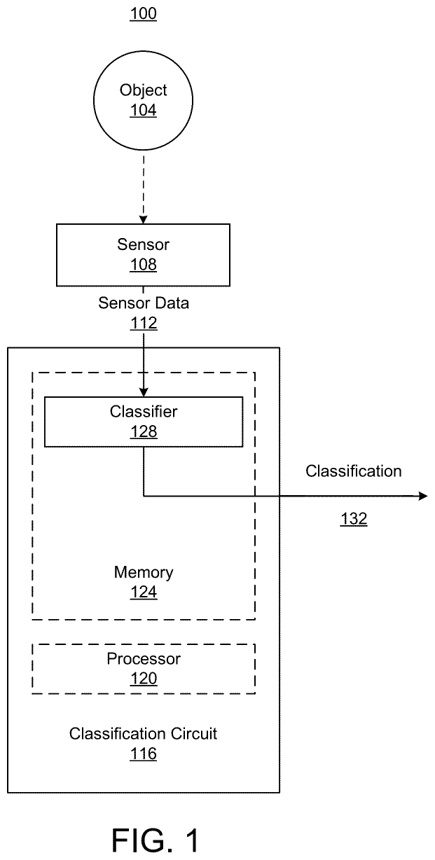

FIG. 1 depicts an example of a sensor system 100. The sensor system 100 can be used to detect sensor data regarding one or more objects 104. The objects 104 can include samples of physical materials, such as biological and/or chemical materials. For example, the objects 104 can include cellular material, nucleic acid material, biological material, chemical material, or any combination thereof.

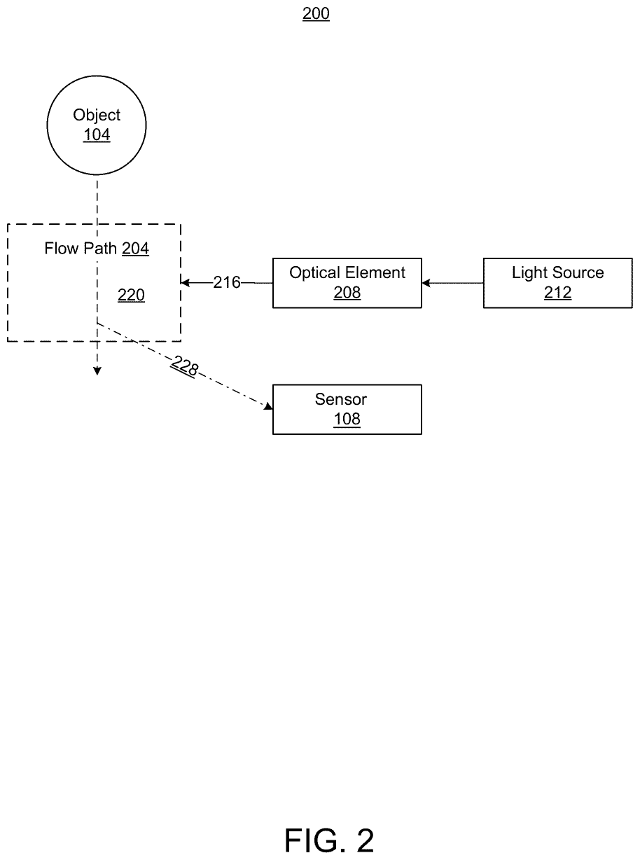

The sensor system 100 can include at least one sensor 108. The sensor 108 can include any of various sensors that can detect sensor data 112 regarding the one or more objects 104. The sensor 108 can output the sensor data 112 (e.g., an electrical signal representative of the data, such as a waveform signal including morphological information of the object 104 (e.g., representative of an object type of the corresponding object 104) or a GMI waveform signal as described with reference to FIG. 2, e.g., a time-series electrical signal representative of an electromagnetic wave detected regarding a respective object 104). For example, the sensor 108 can generate and/or store a data structure that includes the sensor data 112, and which can include at least one of an identifier of the object 104, an identifier of the sensor 108, or a time point when sensor data 112 is detected. The sensor 108 can output the data structure, e.g., as an electrical signal, to one or more remote devices, including in a periodic manner (e.g., output each data structure individually), continuously, or in a batch arrangement. The sensor 108 can include one or more photosensors/photodetectors such as photomultiplier tubes and/or one or more image capture devices.

In some implementations, the overall system including the sensor system 100 can be implemented as a flow cytometer system including at least one cytometer, such as a flow cytometer. The flow cytometer may be a flow cytometer as set forth in U.S. Pat. No. 11,098,275, issued on Aug. 24, 2021, U.S. Pat. No. 11,630,293, issued on Apr. 18, 2023, U.S. Pat. No. 11,598,712, issued on Mar. 7, 2023, U.S. Patent Application Publication No. 2023/0012588, published Jan. 19, 2023, U.S. Patent Application Publication No. 2023/0039952 published Feb. 9, 2023, and U.S. Patent Application Publication No. 2023/0090631, published Jan. 18, 2024, the entire contents of each of which are incorporated herein, including for the flow cytometry systems and methods therein.

The flow cytometer can include at least one light source (e.g., a laser) that can output light towards a fluid flow in which the object 104 is provided, and can include at least one detector to receive an output signal from scattering of the light signal by the object 104. The scattering (and thus the output signal) can represent one or more characteristics of the object 104, and can correspond, in some implementations, to a pattern of the light outputted by the light source. The characteristics may include, for example, morphological aspects or changes, as set forth, for example, in U.S. Patent Application Publication No. 2021/0310053, published on Oct. 7, 2021, the entire contents of which are incorporated herein by reference, including for the identification techniques set forth therein. The light pattern can be, for example, a light pattern as set forth in U.S. Pat. No. 10,761,011, issued on Sep. 1, 2020, the entire contents of which are incorporated herein by reference including for the imaging techniques set forth therein. The detector can generate the sensor data 112 for the flow cytometer to output as the electrical signal.

FIG. 2 depicts an example of a flow cytometer 200 that can be used as the sensor 108. The flow cytometer 200 can use light patterns for detecting information regarding objects, including for classification of objects, without generating images of the objects. For example, the flow cytometer 200 can generate GMI waveforms, such as electromagnetic signals representative of one or more characteristics of the objects, without generating images of the objects. In some implementations, the flow cytometer can be operated in a mode to perform analysis of captured images of objects, such as for classification. In some implementations, the flow cytometer 200 is configured to perform fluorescent activated cell sorting (FACS) and/or operate in a FACS mode. In some implementations, one or more components of the flow cytometer 200 are implemented by the sensor system 100 (or vice versa).

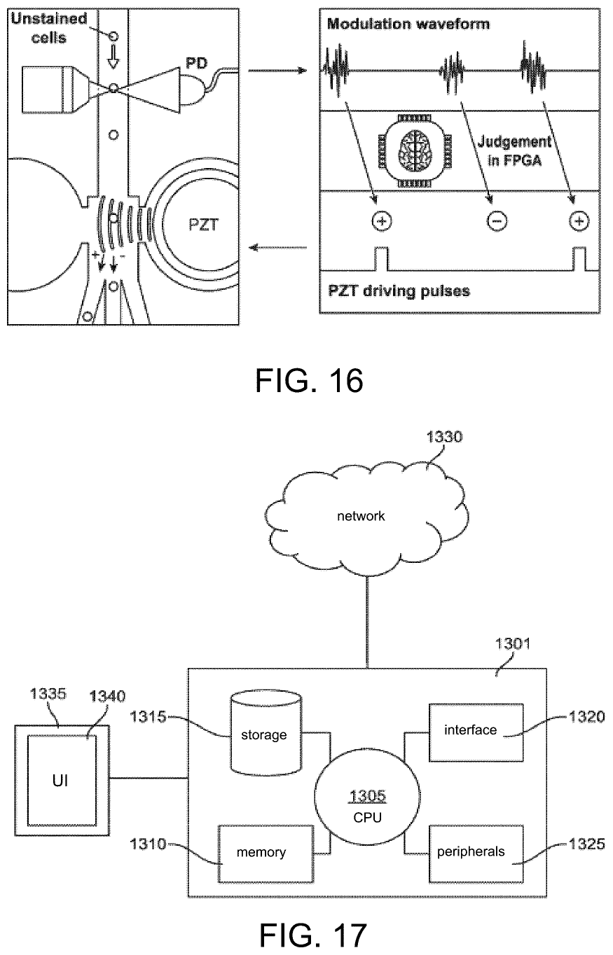

FIG. 16 depicts an example of a sorter (a sorting device) configured to carry out label-free sorting utilizing ghost cytometry. In some implementations, a field-programmable gate array (FPGA) is configured to implement a machine learning classifier to classify each cell passing by the photosensor/photodetector (PD). The cells can be unstained. The FPGA is configured to send pulses to a piezoelectric (PZT) actuator to actuate the actuator to move cells identified as cells of interest to an adjacent channel. More particularly, the modulation waveform is analyzed by the FPGA (e.g., the FPGA carries out a judgment to analyze the modulation waveform) and then provided to cause driving of the PZT actuator.

For example, the flow cytometer 200 can include at least one flow path 204. Fluid in which objects 104 are disposed can be flowed through the flow path 204 (e.g., by a pump or gravity), such as to be directed through a field of view of the sensor 108. The pump can be configured to supply fluid through a flow path in which the objects 104 are disposed.

The flow cytometer 200 can include at least one optical element 208. The optical element 208 can cause a pattern to be applied to light (e.g., from light source 212), such as a random pattern or a structured pattern or can change light from light source 212 into light having a certain pattern (e.g., a uniform pattern, a random pattern or another pattern). The optical element 208 can include, for example, lenses, mirrors (e.g., micro-mirrors), gratings, diffractive optical elements (DOEs), or various combinations thereof. The optical element 208 may be a cylindrical lens to focus the light from the light source 212.

The optical element 208 can be disposed along a light path 212 between a light source 212 and a region 220 in the flow path 204. The light source 212 can include, for example, a laser or a light emitting diode (LED) or an LED array, for example. The light source 212 can output light along the light path 212 to illuminate the objects 104 flowed through the flow path 204. The optical element can cause the light from the light source 212 to be pattered so that the objects 104 are illuminated in the region 220 with an illumination pattern (e.g., a structured and/or a random illumination pattern imparted by the optical element 208), such as for the flow cytometer 200 to operate in a structured light mode. In some embodiments, the illumination pattern is achieved by providing a glass diffuser in the form of a diffractive optical element (DOE). The DOE can be positioned with respect to the light source 212 to achieve the illumination pattern.

As noted above, the flow cytometer system can include a sensor 108 (e.g., a light-receiving unit; a light receiver or receptor). The sensor 108 can receive at least one electromagnetic wave 228 from reflection and/or scattering of the illumination pattern by the objects 104 in the flow path 204.

The sensor 108 can convert the electromagnetic wave into one or more electrical signals. For example, the sensor 108 can include one or more photodetectors to convert optical signals into electrical signals indicative of properties of the optical signals. The sensor 108 can output the electrical signals to represent a waveform, such as to represent amplitude over a period of time of the waveform, corresponding to the electromagnetic wave 228 from the objects 104. The electrical signals can be GMI waveforms (e.g., waveforms representative of the objects 104 without generation of an image of the objects).

Referring further to FIG. 1, the sensor system 100 can include a classification circuit 116, which can include one or more processors 120 and one or more memories 124. The one or more processors 120 can be a general purpose or specific purpose processors, an application specific integrated circuit (ASIC), one or more field programmable gate arrays (FPGAs), a group of processing components, or other suitable processing components. The processors 120 can execute computer code and/or instructions stored in the memories or received from other computer readable media (e.g., CDROM, network storage, a remote server, etc.). The processors 120 can be configured in various computer architectures, such as graphics processing units (GPUs), distributed computing architectures, cloud server architectures, client-server architectures, or various combinations thereof. One or more first processors 120 can be implemented by a first device, such as an edge device, and one or more second processors 120 can be implemented by a second device, such as a server or other device that is communicatively coupled with the first device. The one or more second processors may have different (e.g., greater) processor and/or memory resources than the one or more first processors. The memory 124 can include one or more devices (e.g., memory units, memory devices, storage devices, etc.) for storing data and/or computer code for completing and/or facilitating the various processes described in the present disclosure. The memories 124 can include random access memory (RAM), read-only memory (ROM), hard drive storage, temporary storage, non-volatile memory, flash memory, optical memory, or any other suitable memory for storing software objects and/or computer instructions. The memories 124 can include database components, object code components, script components, or any other type of information structure for supporting the various activities and information structures described in the present disclosure. The memories 124 can be communicably connected to the processors 120 and can include computer code for executing (e.g., by the processors 120) one or more processes described herein. The classification circuit 116 can be communicably coupled with various components of the system 100, such as the sensor 108, such as to retrieve sensor data regarding an object from the sensor 108, or from one or more data sources (e.g., data sources 304).

In some implementations, the classification circuit 116 is or includes a field programmable gate array (FPGA). For example, the classification circuit 116 can be an FPGA that includes (e.g., implements) at least a portion of the one or more processors 120 and memory 124 and/or the functions of the one or more processors 120 and memory 124. For example, the FPGA can execute the classifier 128, such as to execute the classifier 128 on sensor data 112 from a flow cytometer through which the one or more objects 104 (e.g., one or more cells) are flowed. Certain implementations can mitigate challenges for hardware devices in performing classification operations on sensor data regarding objects, such as sensor data represented by the electrical signals outputted by the sensor 108, with both sufficient classification performance (e.g., accuracy, precision, recall, and/or FI score) and speed (e.g., to allow for real time or near-real time processing speed, such as to classify objects at a classification rate about equal to a flow rate of the objects being passed through the sensor 108 and/or a data rate of output from the sensor 108. In particular, by configuring the FPGA 116 to execute components of the sensor system 100, such as the classifier 128, the FPGA 116 can achieve enhanced target classification performance and speed, allowing for greater throughput of objects for observation and classification through the sensor system 100.

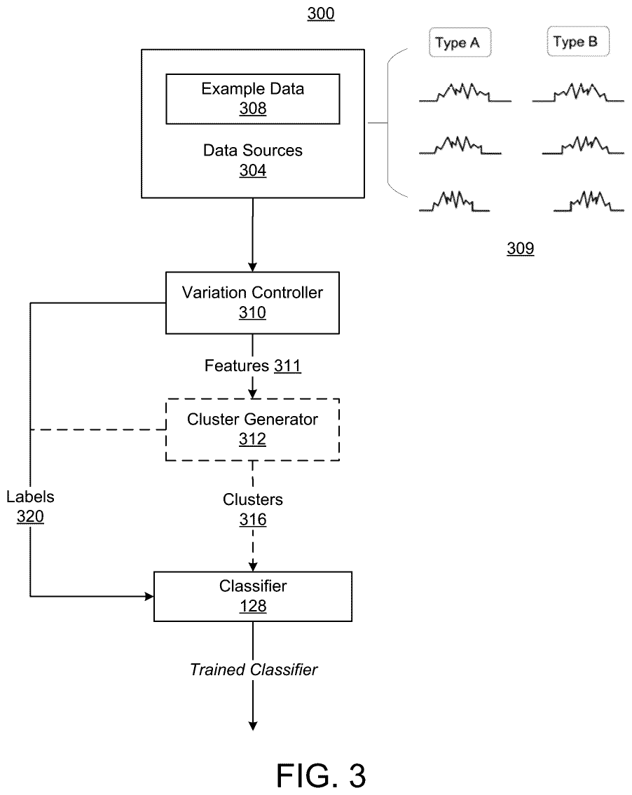

Referring further to FIG. 1, the classification circuit 116 can include at least one classifier 128. The classifier 128 can include one or more functions, rules, heuristics, policies, code, logic, machine learning models, algorithms, or various combinations thereof to perform operations including classification of objects 104 based on sensor data 112 regarding the objects 104, including by processing the sensor data 112 using a feature extractor and/or one or more classifiers (e.g., for object type or other classification predictions) to control for variations of the sensor data 112 relative to data used to train the classifier 128. The classifier 128 can include one or more supervised machine learning models (e.g., as described with reference to FIG. 3) that can be trained to determine a classification 132 of a given object 104 based on the sensor data 112 regarding the given object 104, such as by having the sensor data 112 applied as input to the classifier 128. The classifier 128 can output a data signal representative of the classification 132. For example, the classifier 128 can generate the data signal to include the classification 132, and to include information regarding the object 104 represented by the sensor data 112, such as at least one of the identifiers of the object 104, the identifier of the sensor 108, or the time point at which the sensor data 112 is detected.

### Training Machine Learning-Based Classifiers

FIG. 3 depicts an example of a training system 300 (e.g., classifier training system). The classifier training system 300 can be used to configure (e.g., train, update, calibrate, perform supervised learning of) the one or more classifiers 116 described with reference to FIG. 1. In some implementations, one or more components of the training system 300 are implemented by the sensor system 100 (or vice versa). As described further herein, the classifier(s) 128 can be configured based on training data that includes a plurality of clusters generated by dimensionality reduction of example data (e.g., example data 308) regarding example objects, such as dimensionality reduction that generates clusters and/or processes the example data into a reduced dimensional space (e.g., UMAP, among other dimensionality reduction operations described herein), such as for assigning a gate to a region of the reduced dimensional space. For example, based on such configuration, during inference operation of the classifier(s) 128, the classifier(s) 128 can assign a classification to an object (e.g., represented by sensor data 112), where at least one cluster of the plurality of clusters is associated with the classification.

The training system 300 can include or be coupled with one or more data sources 304. The data sources 304 can be maintained by any of various entities, such as to be provided as part of, or remotely coupled with, any of various systems or devices described herein.

The data sources 304 can include example data 308. The example data 308 can include data regarding objects 104 (e.g., example objects) based on light reflected or scattered by the objects 104. The example data 308 can be analogous to the sensor data 112. For example, the example data 308 can include data outputted by sensors 108, such as GMI waveforms (e.g., time-series electrical signals representative of GMI waveforms obtained and/or outputted by the flow cytometer 200). The example data 308 can include images of the objects 104, such as cell images captured by an image captured device or cell images reconstructed with waveforms detected by sensors 108.

The example data 308 can include one or more identifiers of the objects 104 and/or a given sensor 108 that generates the data regarding the objects 104, such as an identifier of a subject (e.g., a patient) from which a given object 104 is retrieved, or a condition of the subject or the object 104 (e.g., a pathology or a pathological condition, such as a condition associated with the object 104 corresponding to a tumor and/or cancerous tissues). For example, the example data 308 can be a plurality of example data elements, each example data element including sensor data regarding a given object 104 and an identifier of the given object 104. The identifiers can represent types of the objects 104.

In some implementations, the example data 308 are not assigned labels (e.g., predetermined labels) of a classification for the example data 308. For example, the example data 308 may not be assigned any identifiers of cell types or molecular marker expression. For example, the example data 308 can correspond to data for which classification information is not available. In some implementations, at least some example data 308 is assigned labels, although the training system 300 may not use the assigned labels for at least some of the operations described further herein.

The example data 308 can include data associated with different times of detection. For example, the example data 308 can include example data elements of which at least two example data elements have a different time of detection (e.g., that differ by at least a time threshold). The time threshold can be on the order of seconds, minutes, hours, or days, such as to differ by a sufficient amount that variation in example data elements is expected. Such variation may be due, e.g., to instrumental fluctuation, biological variability, or measurement conditions, or any combination thereof. The example data 308 can include data associated with at least one of different subjects or different sample tubes, which can also result in the example data elements having variations (e.g., a first example associated with a different subject (or different sample tube) than a second example). For example, as shown in FIG. 3, waveforms 309 for example data 308 from three sample tubes and of two types, Type A and Type B, can have variations in patterns even where the waveforms 309 correspond to the same type.

The training system 300 can perform training operations using various batches of example data 308. For example, the training system 300 can assign at least a first subset of the example data 308 to a first batch, e.g., a training batch, and a second subset of the example data 308 to a second batch, e.g., a test and/or validation batch. The training system 300 can assign the example data 308 to batches randomly, based on instructions for the assignments, and/or based on evaluation of statistical features of the batches (e.g., so that the training batch and test batch are relatively similar). The training system 300 can perform cluster generation and training of the classifier 128 using the training batch and can validate the performance of the trained classifier 128 using the test batch.

The training system 300 can include at least one variation controller 310. The variation controller 310 can include one more functions, rules, heuristics, policies, code, logic, machine learning models, algorithms, or various combinations thereof to perform operations including generating outputs from the example data 308 that control for variations in the example data 308. For example, the variation controller 310 can predict classifications of the example data 308 and/or detect features from the example data 308 that can be used for dimensionality reduction.

For example, the variation controller 310 can be or include a feature extractor. The feature extractor can process the example data 308 to detect one or more features 311 from the example data 308, such as features 311 that satisfy at least one of a reproducibility criterion or a differentiation criterion. The feature extractor can include a machine learning model, such as a supervised machine learning model, such as a neural network or a decision tree (e.g., a gradient boosting decision tree). The variation controller 310 can assign an identifier of the example data element (and/or the object corresponding to the example data element) to the feature(s) 311 extracted for the example data element.

The training system 300 can apply the example data 308 (e.g., data having variability with respect to time or subjects of measurement) as input to the feature extractor to cause the feature extractor to generate the one or more features 311. A count of the features 311 can be less than a count of dimensions of the example data 308 (e.g., each example data element can represent sensor data, such as a waveform, of 1024 dimensions, while the feature extractor can output 128 features). The features 311 can be aspects of the example data 308 that are common to multiple example data elements.

The training system 300 can select at least one feature 311 of the one or more features 311 that satisfies at least one of the reproducibility criterion or the differentiation criterion. The reproducibility criterion can include whether a given feature 311 (e.g., a value of a given feature 311, such as whether a type of the object having the given feature 311 is of a first type or a second type) is similarly represented across a plurality of example data elements. For example, the reproducibility criterion can include a threshold (e.g., maximum threshold) for a distance between at least a subset of the example data elements of the example data 308, such as to detect that example data elements for features 311 that fall within the threshold are reproducible (e.g., consistently map to similar locations in a feature space, such as a UMAP space as described further herein). As such, the variation controller 310 can be used to select, amongst the features 311 determined for the example data 308, a subset of features 311 that are reproducible across the example data 308, such as features 311 that are limited in variation (e.g., even if the example data 308 itself, such as shown for waveforms 309, does have variations).

The differentiation criterion can include whether distinct features 311 and/or distinct values of a given feature 311, including but not limited to different types (e.g., cell types), are sufficiently differentiated to allow for effective detection of the given feature 311 from the example data 308 (and/or from sensor data 112). For example, the differentiation criterion can include a threshold (e.g., minimum threshold) between at least a subset of the example data 308, such as in a feature space in which the features 311 are defined. For example, the differentiation criterion can indicate whether the given feature 311 allows for distinguishing amongst objects that map to the feature 311 (or a value of the feature 311) or do not map to the feature 311.

In some implementations, the variation controller 310 (e.g., the feature extractor) is configured to determine (e.g., predict) the classifications of the example data 308. The variation controller 310 can include, for example, a supervised machine learning model, such as a neural network, trained to predict classifications (or to perform regression) based on at least some labelling of the example data 308 (e.g., with classifications such as cell types, or with regressions such as marker gene expression levels). For example, this can allow the variation controller 310 to account for variations amongst the example data 308.

Referring further to FIG. 3, the training system 300 can include at least one cluster generator 312. The cluster generator 312 can include one or functions, rules, heuristics, policies, code, logic, machine learning models, algorithms, or various combinations thereof to perform operations including dimensionality reduction and/or clustering of example data 308, such as to generate clusters 316 (and/or to generate gates corresponding to the clusters 316). The cluster generator 312 can include a machine learning model configured to perform unsupervised learning on the generate clusters 316 and/or gates with respect to the example data 308 (e.g., to generate the plurality of clusters without the predetermined labels of the example data 308). For example, the cluster generator 312 can receive the example data 308 and can output clusters 316 indicative of example data 308 grouped according to features of the objects 104 as represented by the example data 308. The clusters 316 can correspond to different types (e.g., classes/classifications) of objects 104. For example, the cluster generator 312 can generate, based on the example data 308, a first cluster 316 having a first type and a second cluster 316 having a second type. The cluster generator 312 can perform the dimensionality reduction on features 311 outputted by the variation controller 310 (e.g., rather than on the example data 308 itself), such as to facilitate controlling for variations in the example data 308. For example, the cluster generator 312 can apply the dimensionality reduction (e.g., and without limitation, UMAP, PCA, t-SNE, and/or using an autoencoder) to the features 311 of the example data 308 to map the feature 311 (and in turn, the example data elements having the features 311) to the low-dimensionality space.

In some implementations, the cluster generator 312 performs dimensionality reduction of the example data 308 to determine the clusters 316 (e.g., to generate the plurality of clusters). For example, the example data 308 (e.g., sensor data of the example data 308) can be indicative of a plurality of dimensions of features, such as 1024 dimensions. The dimensions can represent complexity of the waveforms of the example data 308, such as a number of distinct characteristics of the samples represented by the waveforms (e.g., by amplitude of the waveforms over time), which can be a relatively large number, such as on the order of hundreds or thousands. The cluster generator 312 can process the example data 308 to convert the example data 308 into data of a reduced number of dimensions of features (where at least a portion of the features of the reduced number of dimensions of features can be different than those of the example data 308). In some implementations, the reduced number of dimensions is greater than or equal to 1 and less than or equal to about 10, and may be any integer therebetween. A representation of the example data 308 in the low-dimensional space can correspond to a graph or a histogram, for example.

In some implementations, the cluster generator 312 performs dimensionality reduction by determining a distance between each pair of waveforms of the example data 308, and assigning the example data 308 to points in a low-dimensional (e.g., two-dimensional) space based on the determined distances, such that points for example data 308 having lesser distances are arranged closer in the two-dimensional space. In some implementations, the cluster generator 312 determines the distance between two waveforms of the example data 308 as an area between the two waveforms. The cluster generator 312 can determine the clusters based on the locations of the points of the example data 308 in the two-dimensional space and one or more criteria for the clustering, such as a target size for the clusters 316 (e.g., number of elements of example data 308 per cluster and/or radius (e.g., average, median, etc.) of the clusters 316).

The cluster generator 312 can perform a UMAP operation to perform the dimensionality reduction for determining the clusters 316 from the example data 308. For example, the cluster generator 312 can determine a k-nearest neighbor (kNN) graph representation of the example data 308 according to the distances amongst the pairs of example data 308, in which each element of example data 308 is assigned to a point in a low-dimensional (e.g., two-dimensional space), and can have one or more neighbors (e.g., k neighbors) corresponding to the determined distances. The cluster generator 312 can iteratively update the graph representation, e.g., update locations of the example data 308 in the two-dimensional space, until a convergence criterion is achieved.

The cluster generator 312 can perform PCA to perform the dimensionality reduction for determining the clusters 316 from the example data 308. The cluster generator 312 can perform PCA to map the high-dimensional data of the example data 308 to a selected number of dimensions, e.g., two dimensions. This can be useful for clustering the example data 308, as the PCA operation can extract useful signal information for classification from the example data 308 into a relatively low number of dimensions.

In some implementations, the cluster generator 312 performs t-SNE to perform the dimensionality reduction for determining the clusters 316 from the example data 308. For example, the cluster generator 312 can determine a probability distribution over pairs of the example data 308 such as example data 308 that are similar are assigned a higher probability while example data 308 that are dissimilar are assigned a lower probability. The cluster generator 312 can determine a corresponding probability distribution in a low-dimensional space (e.g., having a number of dimensions that can be predetermined, adapted, and/or learned), and as a convergence criterion can reduce or minimize a difference, such as a Kullback-Leibler divergence (KL divergence), between the two distributions with respect to the locations of the example data 308 in the dimensional spaces.

In some implementations, the cluster generator 312 includes an autoencoder to perform the dimensionality reduction. For example, the autoencoder can include an encoder to encode the example data 308 into a latent space (which can have a predetermined and/or selected number of dimensions) and a decoder to process the encoded example data 308 from the latent space into the original dimensional space of the example data 308. The autoencoder can be a pre-trained (i.e., trained in advance) machine learning model and/or can be trained or updated based on encoding of example data 308 into the latent space. The cluster generator 312 can determine the clusters 316 in the latent space.

The cluster generator 312 can perform at least a first dimensionality reduction on the example data 308 using a first operation (e.g., PCA), and can perform at least one a second dimensionality reduction (e.g., UMAP) based on the output of the first dimensionality reduction. For example, the cluster generator 312 can perform PCA to pre-process the example data 308, and can concatenate the results of the PCA to the example data 308 for inputting to the UMAP operation.

In some implementations, the cluster generator 312 is configured to perform the dimensionality reduction as a clustering operation on the example data 308. For example, the cluster generator 312 can execute one or more clustering algorithms, including, for example and without limitation, k-means clustering, density-based spatial clustering of applications with noise (DBSCAN), hierarchical clustering, spectral clustering, or various combinations thereof, to cluster the example data 308. In some implementations, the cluster generator 312 receives an instruction for the clustering (e.g., a number of clusters k for k-means clustering), and performs the clustering according to the instruction.

Referring further to FIG. 3, the training system 300 can assign one or more labels (e.g., artificial labels determined based on the clustering, rather than predefined and/or predetermined labels in the data sources 304) to one or more corresponding clusters 316. For example, the training system 300 can assign labels that indicate identifier(s) common to at least a subset of the example data 308 of the one or more corresponding clusters 316. This can include, for example, indicating whether example data 308 correspond to patient samples, or express molecular markers. The labels can include an identifier of the cluster 316 to which the example data 308 is assigned. The labels can include, for example and without limitation, an identifier of a cell type of a cell corresponding to a given element of example data 308, such that the cluster 316 to which the given element of example data 308 is assigned is labeled with the cell type of the cell.

In some implementations, the training system 300 assigns at least one gate to the clusters 316. For example, the training system 300 can define a region in the low-dimensional space (e.g., a region bounding one or more portions of the low-dimensional space) in which each example data 308 of a given cluster 316 is located. The gate can be used as a filter for classification and/or training of classifiers 128. For example, the training system 300 can assign a first classification to the example data 308 of one or more first clusters 316 around which the gate is defined and can assign a second classification different from the first classification to the example data 308 of one or more second clusters 316 outside of the gate. In some implementations, the example data 308 of the one or more first clusters 316 are assigned a first value of a flag to indicate that the example data 308 is in the gate, and the example data 308 of the one or more second clusters are assigned a second value of the flag to indicate that the example data is outside the gate. The training system 300 can assign a first gate for target data, and a second gate for non-target data. The training system 300 can receive a selection of one or more clusters 316. The training system 300 can receive the selection by various inputs, such as user input. For example, the training system 300 can receive an input indicating the selection of the one or more clusters 316 as a user interface input (e.g., via a mouse or keyboard), such as an input indicating a polygon, circle or rectangle (i.e., a box) to define the gate (e.g., around the selected clusters 316). This can allow for the classifiers 128 to be targeted towards data and/or classification tasks of interest in a manner responsive to the user input. For example, responsive to detecting the user interface input, the training system 300 can generate the gate to correspond to the region (of the space in which the clusters 316 are defined) defined by the user interface input.

As noted above, inputs in the form of polygons, circles or rectangles (boxes) can be used to define gates in some implementations. However, gating according to certain exemplary implementations is not limited to these particular forms. In some implementations, manual gating can be performed using boundary gates to exclude particular data (e.g., a population) above a specified threshold in one-dimensional or two-dimensional plots. In particular, a boundary gate can be established by selecting an uppermost limit of the gate such that data below the selected boundary is included in a rectangular gate. In some implementations, rectangular gates are employed for data in two-dimensional plots. To establish a rectangular gate, two diagonal points defining the limits of a population can be selected, so as to allow a rectangle to be constructed around the population. In some implementations, a polygonal gate or an ellipsoid (elliptical) gate can be used for populations in two-dimensional plots. In particular, ellipsoid gates can be established around a population by selecting several (e.g., four) points that encompass the population. In some implementations, interval gates are used for gating a population in either one-dimensional or two-dimensional plots between an upper limit and a lower limit. In particular, interval gates can be established by selecting both the lower and upper boundaries of a population and then constructing a rectangular gate around the population. In some implementations, threshold gates can be used to gate a population in one-dimensional or two-dimensional plots that lie above a particular threshold. In contrast to boundary gates, a threshold gate can be established by selecting the lowermost limit of the population to construct a rectangular gate around the population above the threshold. In some implementation, quadrant gates can be used to gate four populations in two-dimensional plots. In some implementations, web gates can be utilized to gate multiple populations around a central location. In some implementations, multiple or mixed gates can be constructed where there are multiple populations. As yet a further example, negated gates can be used to gate populations outside of (i.e., excluded from) a constructed gate. It should be appreciated that the foregoing are merely illustrative examples of potential gating techniques and that other gating techniques may be used in connection with the present disclosure.

Referring further to FIG. 3, the training system 300 can assign the at least one gate to the one or more features 311 that the training system 300 selected to satisfy the at least one of the reproducibility criterion or the differentiation criterion (and/or clusters 316 corresponding to the features 311 selected to satisfy the at least one of the reproducibility criterion or the differentiation criterion). For example, the training system 300 can assign the at least one gate to a portion of the low-dimensional space (in which the dimensionality reduction is performed) in which the selected one or more features 311 are located. This can allow the training system 300 to perform gating based on the location of target cell types in the training data represented by the example data 308.

In some implementations, the variation controller 310 can detect features 311 that are not (explicitly) represented in the example data 308, such as features 311 that the example data 308 have not been labeled with. As such, the training system 300 can assign the at least one gate to features 311 that may or may not be in the training data but are detectable in the low-dimensional space in which the features 311 are defined.

The training system 300 can perform supervised learning of the classifier 128 based on the clusters 316 and the labels assigned to the clusters 316, such as to generate a trained classifier 128. As such, the training system 300 can facilitate training of the classifier 128 based on the clustering performed by the cluster generator 312, rather than predetermined labels assigned to the example data 308. The classifier 128 can be implemented using any of various machine learning models useful for classification. The classifier 128 can include neural-network based classifiers. The training system 300 can configure the classifier 128 based on the at least one gate (e.g., the at least one gate selected based on dimensionality reduction of the features 311).

For example, the training system 300 can apply the example data 308 as input to the classifier 128 to cause the classifier 128 to generate candidate outputs, can compare the candidate outputs with at least one of the clusters 316 or the labels, and can update the classifier 128, such as by updating one or more parameters of the classifier 128 (e.g., weights, biases, coefficients, machine learning model architecture structures) based on the comparison. The training system 300 can iteratively perform inputting of the example data 308 to the classifier 128 and updating of the classifier 128 based on the comparisons of the candidate outputs with the at least one of the clusters 316 or the labels until one or more convergence criteria are achieved (e.g., using an optimization function, including but not limited to gradient descent).

In some implementations, the classifier 128 includes at least one support vector machine (SVM). The SVM can be useful for the classification of sensor data 112 due to its effectiveness in handling the dimensionality of the sensor data 112, while avoiding overfitting. The SVM can include one or more hyperplanes that separate the example data 308 in a manner representative of the clusters 316, so that the SVM (e.g., the hyperplanes of the SVM) can receive new data inputs (e.g., sensor data 112) and classify the new data inputs according to the one or more hyperplanes. For example, the training system 300 can train the SVM to determine the one or more hyperplanes to achieve at least one criteria (e.g., maximize or optimize) the positioning of the one or more hyperplanes relative to the clusters 316. For example, the training system 300 can train the SVM by applying the example data 308 as input to the SVM. The inputting of the example data 308 can cause the SVM to (i) determine one or more candidate hyperplanes, (ii) evaluate an objective function for the one or more candidate hyperplanes (e.g., based on determination of distances between the one or more candidate hyperplanes and the clusters 316 (e.g., the example data 308 of respective clusters)), and (iii) update one or more parameters (e.g., weights) of the one or more candidate hyperplanes to achieve one or more convergence criteria.

The classifier 128 can include at least one regression function, such as a logistic regression function. Implementing the classifier 128 as a regression function can facilitate classification of sensor data 112 due to the efficiency of training the regression function, and the speed of the regression function in processing new sensor data 112. The training system 300 can train the logistic regression function by applying the example data 308 as input to the logistic regression function, causing the logistic regression function to generate one or more candidate outputs (expected to be representative of whether the example data 308 belong to given clusters 316), evaluating an objective function, such as a cost function, based on the candidate outputs and the assignments of example data 308 to clusters 316, and updating parameters of the logistic regression function according to the evaluation.

In some implementations, the classifier 128 can include at least one decision tree. The decision tree can be useful for processing of sensor data 112 due to the interpretability of the decision tree, e.g., the structure of the decision tree identifying the classifications for the sensor data 112. The training system 300 can train the decision tree using any of various decision tree algorithms, to cause the decision tree to have a structure in which features of the example data 308 are used to define branches from a root node to various leaf nodes, the leaf nodes being representative of the classification of the example data 308 (e.g., to which cluster 316 the example data 308 belong).

In some implementations, the training system 300 performs training of the classifier 128 based on the gate that the training system 300 determined based on the selection of the one or more features 308 that satisfied the at least one of the reproducibility criterion or the differentiation criterion. For example, the training system 300 can assign an indicator (e.g., as label 320) to one or more example data elements of the example data 308 based on whether each of the one or more example data elements is within the gate or outside of the gate. For example, the training system 300 can digitally tag the example data 308 based on the location of the example data 308 relative to the gate. The training system 300 can thus configure the classifier 128 to be capable of performing classification on data that may have measurement variability relative to the example data 308. This can extend the utility of the classifier 128 beyond models that may fail to accurately perform classification under conditions of variability.

Referring further to FIG. 3, as noted above, the variation controller 310 can predict classifications (e.g. labels 320) for the example data 308. The training system 300 can configure the classifier 128 based on the predicted classifications (e.g., predicted object types of a plurality of example data 308). This can allow the training system 300 to configure the classifier 128 to be capable of controlling for variations in received data (e.g., sensor data 112) relative to the example data 308. In some implementations, the use of the predicted classifications can allow the classifier 128 to be trained without the use of the cluster generator 312. UMAP or other operations of the cluster generator 312 can be optionally further performed to validate the predicted classifications.

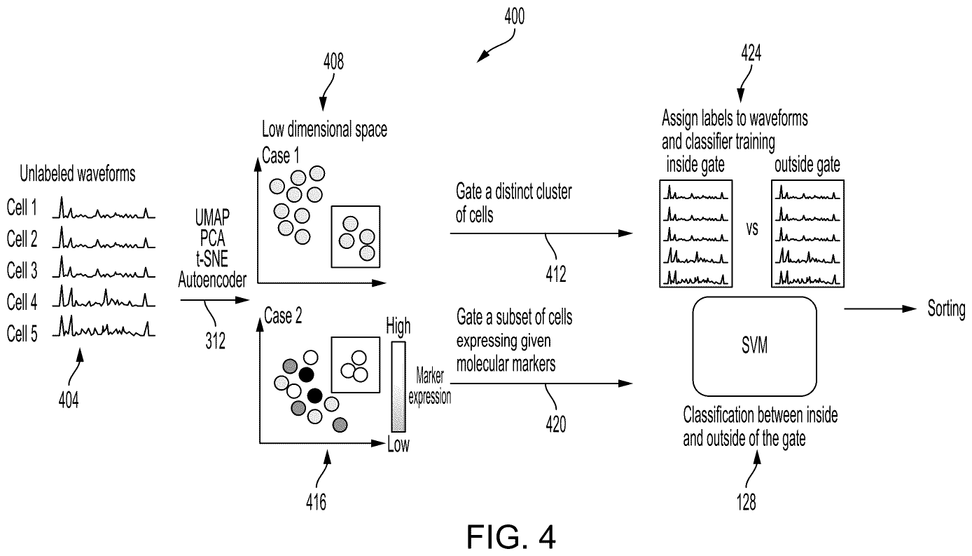

FIG. 4 depicts an example of a process 400 that the training system 300 can perform. As depicted in FIG. 4, unlabeled waveforms 404 can be provided as input to the cluster generator 312 (e.g., as depicted, any one or more of UMAP, PCA, t-SNE, and/or autoencoder), which can perform dimensionality reduction to assign the waveforms 404 to locations in one or more low-dimensional spaces, such as a first space 408 for which the training system 300 performs gating 412 according to the locations of the waveforms 404 and a feature of a selected cluster of waveforms 404 (e.g., belonging to patient samples) and/or a second space 416 for which the training system 300 performs gating 420 according to the locations of the waveforms 404 and molecular marker expression. The training system 300 can assign labels 424 to the waveforms 404 based on the respective gating 412, 420, and can train the classifier 128 (e.g., as depicted, an SVM) using the waveforms 404 and the assigned labels 424. The training system 300 can perform the gating 412 and/or gating 420 according to an input indicating features of the waveforms 404 to include inside the gates or outside of the gates.

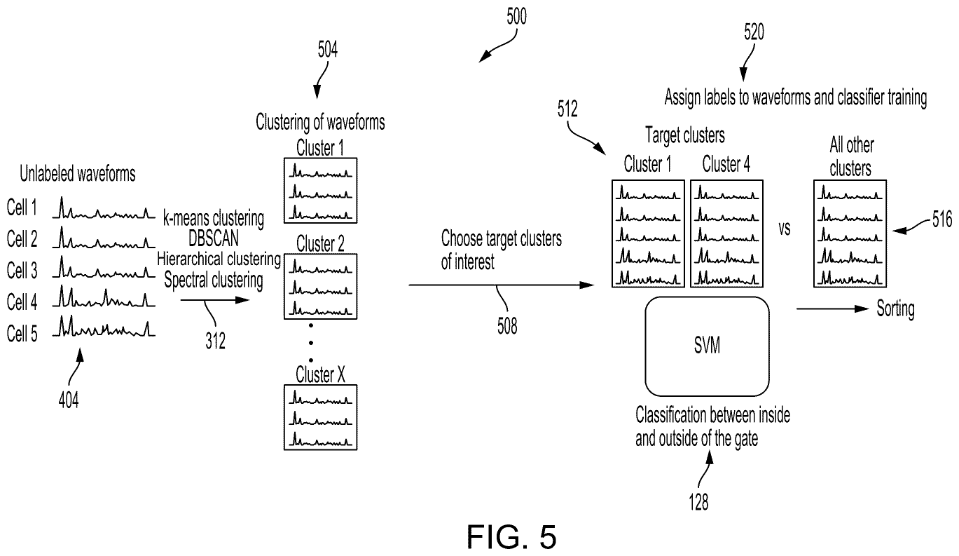

FIG. 5 depicts an example of a process 500 that the training system 300 can perform. As depicted in FIG. 5, unlabeled waveforms 404 can be provided as input to the cluster generator 312 (e.g. and without limitation, as depicted, the cluster generator 312 can execute any one or more of k-means clustering, DBSCAN, hierarchical clustering, and/or spectral clustering), which can cluster the waveforms 404 to assign the waveforms 404 to respective clusters 504. The training system 300 can perform a selection 508 of one or more first clusters 504 as target clusters 512 and one or more second clusters 504 as non-target (e.g., other) clusters 516. The training system 300 can assign labels 520 to the respective waveforms 404 based on the corresponding clusters 512, 516, and can train the classifier 128 (e.g., as depicted, an SVM) using the waveforms 404 and the assigned labels 520. The training system 300 can perform the selection 508 according to an input indicating features of the target cluster(s) 512.

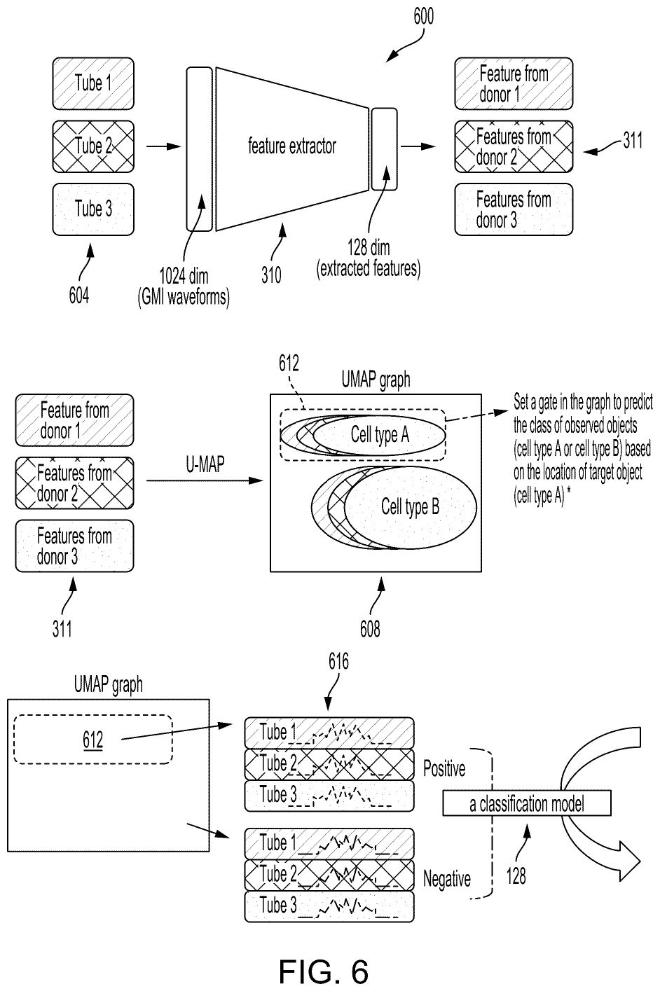

FIG. 6 depicts an example of a process 600 that the training system 300 can perform. As depicted in FIG. 6, data 604 (e.g., waveforms) can be applied as input to the variation controller 310 to cause the variation controller 310 to generate features 311 from the data 604. The features 311 can be processed by dimensionality reduction (e.g., as depicted, with UMAP) to map the features 311 to a low-dimensional space 608 in which a gate 612 can be assigned to distinguish objects of a first type (e.g., cell type A) from other objects (including, for example, cell type B). As depicted in FIG. 6, the features 311 used for assigning the gate 612 can satisfy at least one of a reproducibility criterion (e.g., as depicted, the cell type A features have relatively low variation, even where based on data 604 from different donors) or a differentiation criterion (e.g., as depicted, the cell type A and cell type B features are located far enough apart to allow the gate 612 to effectively differentiate cell type A and cell type B). The gate 612 can thus be used to assign tags 616 (indicative of whether the data 604 are within the gate 612) to the data 604 in order to train the classifier 128 based on the data 604 and corresponding tags 616.

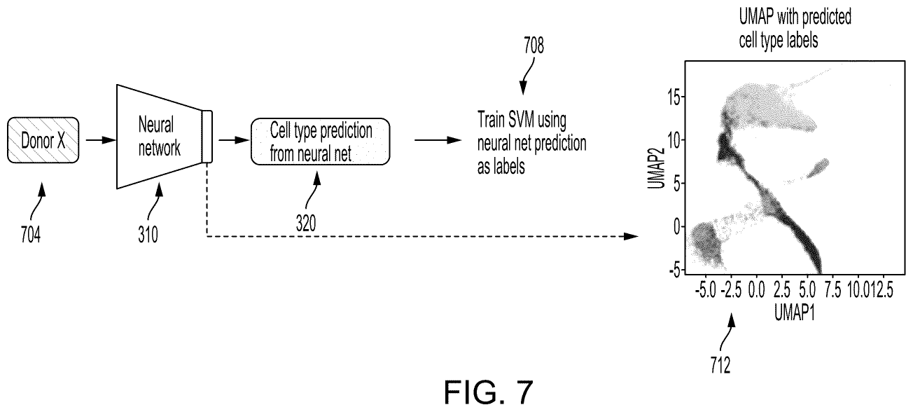

FIG. 7 depicts an example of a process 700 that the training system 300 can perform. Data 704 (e.g., donor data, such as example data 308) can be applied as input to the variation controller 310 (e.g., a supervised machine learning model of the variation controller 310, shown as a neural network) to cause the variation controller 310 to generate a label 320 (e.g., cell type predictions) for the data 704. The data 704 and label 320 can be used to configure the classifier 128, while controlling for variability of the data 704.

Referring further to FIGS. 1 and 3, in some implementations, the classifier 128 is a pre-trained machine learning model. For example, the classifier 128 can be trained (e.g., as described with reference to FIG. 3) in a first one or more operations prior to processing of the sensor data 112 to generate the classification 132 in a second one or more operations. The classification circuit 116 (e.g., the memory 124) can receive the classifier 128 as a machine learning model data structure or can receive one or more parameters of the classifier 128 (e.g., weights, biases, information indicative of structures of the classifier 128), and can update a baseline model based on the received one or more parameters. The pre-training of the classifier 128 can allow for separate processes and/or separated workflows for training of the classifier 128 and execution of the classifier 128, such as to allow for different data and/or sensors to be used for the training relative to the classification.

In some implementations, the classifier 128 is trained and/or updated using the sensor data 112. For example, sensor data 112 regarding a plurality of objects 104 can be obtained, e.g., by being retrieved from a source. In particular, the sensor data 108 can be retrieved and can be processed using the training system 300 to train the classifier 128. Responsive to being trained, the classifier 128 can output classifications 132 of the plurality of objects 104. This can allow for an end-to-end classification of sensor data 112 regarding the plurality of objects 104, such as to distinguish target objects amongst observed objects in a batch of objects 104. In some implementations, the classification circuit 120 can receive identifiers for the classifications 132 (e.g., via a user interface) to assign to the classifications 132.

### Operation of Machine Learning-Based Classifiers

Referring further to FIG. 1, the classifier 128 can be used to determine one or more classifications regarding the one or more objects 104 for which the sensor 108 obtains sensor data 112. For example, the classifier 128 can implement a sorting function to sort target cells from others based on classification results. As discussed above, due to the manner in which the classifier 128 is trained, the classifier 128 can perform classification based on detection of features of the target cells even where the manner in which such features are represented in the sensor data 112 has variations relative to the training data used to train the classifier 128.

The classifier 128 can receive sensor data 112 from the sensor 108 (e.g., the sensor system 100 can apply the sensor data 112 as input to the classifier 128). For example, the sensor 108 can output the sensor data 112 as one or more waveforms (or images, such as cell images) corresponding to one or more objects 104 for which the sensor data 112 is obtained. The sensor data 112 can include the waveforms and can include identifiers of the objects 104. The sensor data 112 can be received by the classifier 128 periodically as outputted from sensor and/or can be retrieved (e.g., in single instances of sensor data 112 or in batches) from the sensor 108 or a data source coupled with the sensor 108. For example, the sensor 108 can be communicatively coupled to a data source from which the sensor 108 is configured to acquire data, e.g., at single instances or intervals.

The classifier 128, responsive to receiving the sensor data 112, can determine the classification 132 of the one or more objects 104. For example, having been trained using the example data 308 (e.g., trained using features 311 extracted from the example data 308 and/or predicted classifications for the example data), the classifier 128 can be capable of processing the sensor data 112 to determine (e.g., predict) the classification for the one or more objects 104. For example, the classifier 128 can be configured to process the sensor data 112 to predict the classification for the one or more objects 104 so as to control for variations that may be present in the sensor data 112 (e.g., relative to other instances of sensor data 112 and/or the example data 308 used to train the classifier 128). In some implementations, the classifier 128 performs the classification on raw data, such as raw waveforms or images. In some implementations, the classifier 128 performs the classification on reduced dimension data. For example, the classifier 128 can process the sensor data in a variable space corresponding to a number of dimensions of the dimensionality reduction, the number of dimensions being greater than or equal to one (e.g., a histogram of sensor data 112) and less than or equal to about ten. The classifier 128 can include or be configured based on one or more gates that distinguish the clusters 316. For example, the classifier 128 can detect the classification 132 of the one or more objects 104 based on a gate distinguishing a first cluster 316 of the plurality of clusters that is associated with the classification 132 (e.g., the first cluster 316 is inside the gate) from a second cluster 316 of the plurality of clusters that is unassociated with the classification 132 (e.g., the second cluster 316 is outside of the gate).

The classifier 128 can output the classification 132 in various formats. For example, the classifier 128 can assign the classification 132 to a data structure that includes the sensor data 112. The classifier 128 can transmit the classification 132 and/or the data structure to a remote device. The classifier 128 can cause a user interface (e.g., a display) to present an indication of the classification 132. The classifier 128 can receive user inputs for operation by way of the user interface (e.g. and without limitation, via a keyboard, mouse, touchscreen, camera, and/or audio input device), such as for defining gates, selection of target cluster(s), and/or causing sorting of cells based on the selection of target cluster(s). The system 100 can present information regarding the operation of the classifier 128 based on inputs received via the user interface; e.g., responsive to selection of a given cluster, the system 100 can present information regarding the given cluster, such as location, shading or color on a heatmap representation of the clusters.

### Examples

The following non-limiting example indicate classification tasks performed using one or more systems described, such as to train and execute the classifier 128, as well as the performance of the classifier 128 on such tasks.

### Bead Sorting

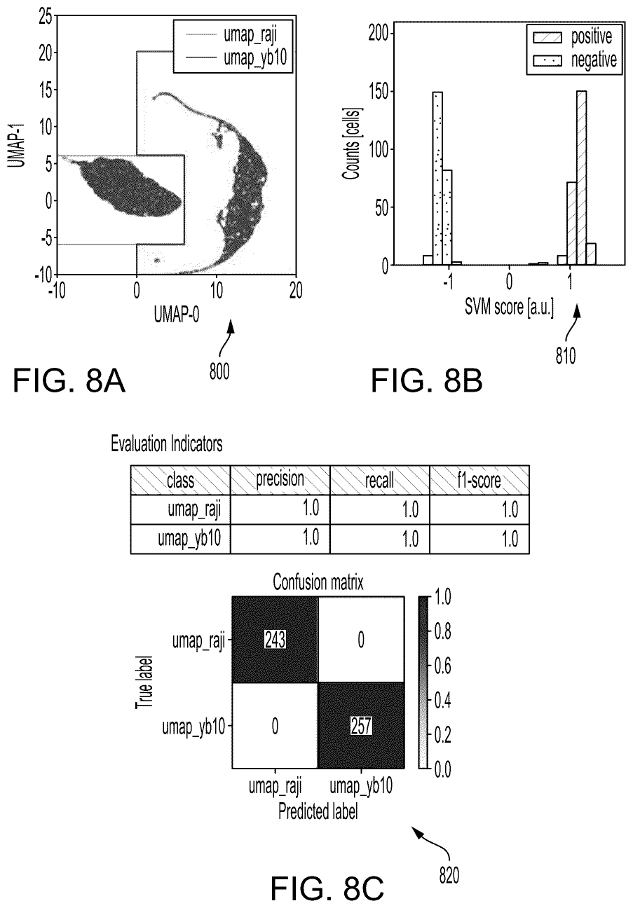

A classifier was used to perform classification to sort yellow beads (as target objects) amongst fixed cells. The classifier was trained based on GMI waveforms of the objects. The GMI waveforms were pre-processed using PCA, the output of which was concatenated to the GMI waveforms to provide as input to UMAP. FIG. 8A depicts in chart 800 the gating of the yellow bead (umap_yb10) objects relative to the fixed cell (umap_raji) in a two-dimensional UMAP space. The classifier was implemented as an SVM that was trained from the gating showing by the chart 800, with SVM scores (the distance of individual data points from the decision boundary of the classifier) shown in chart 810 of FIG. 8B. The perform of the classifier was validated based on performance scores shown in chart 820 of FIG. 8C, including precision, recall, and f1-scores of 1.0 for each class, and shown in the confusion matrix where the predicted class of each object matched its actual label. Upon execution of the classifier on sensor data for new objects, the classifier was able to perform sorting with purity of 99.9%, sorting recovery of 98.8%, coincidence of 2.2%, and throughput of 250 episodes per second.

### Monocyte Isolation in White Blood Cells

A classifier was used to perform sorting of monocytes amongst white blood cells (WBCs). The input sample was WBCs isolated from fresh blood samples of healthy volunteers. The input sample included monocyte and other white blood cell types. Antibody staining was performed with CD14 (monocyte marker) and CD45 (lymphocyte marker) for validation. GMI waveforms of input samples were measured with ghost cytometry.

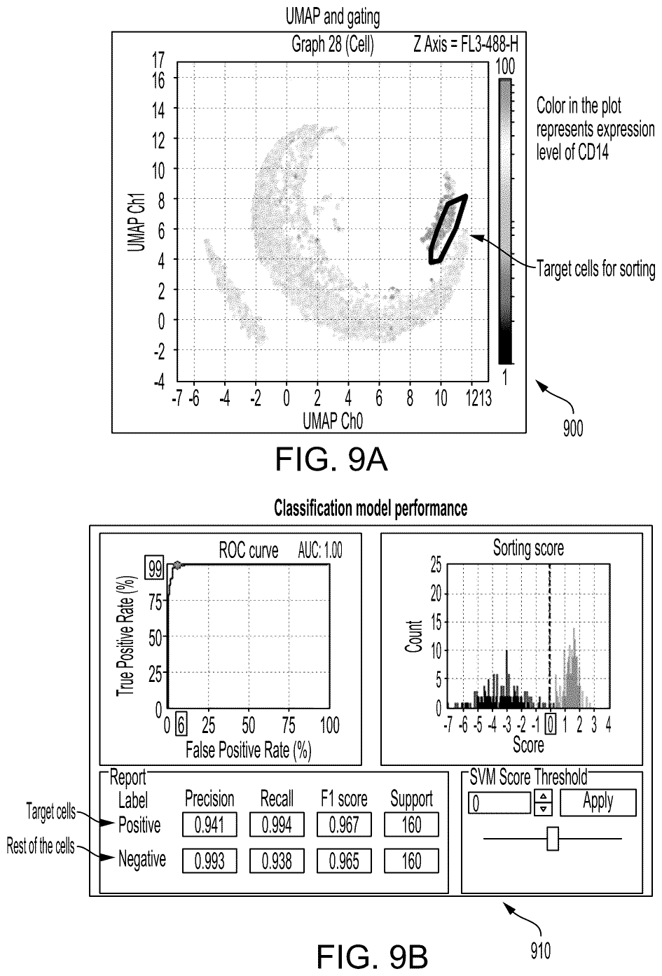

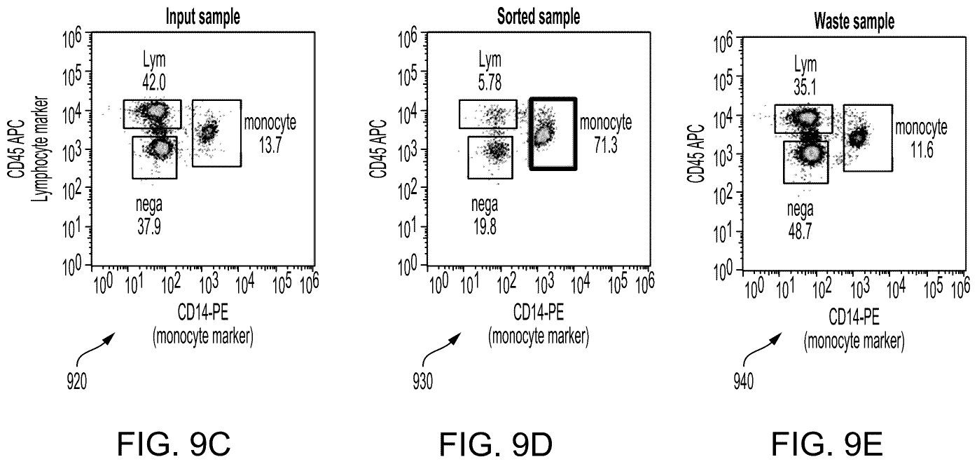

Dimensionality reduction of the GMI waveforms was performed with UMAP. Target cells were defined on the basis of location in the low dimensional space, e.g., using a gate as depicted in chart 900 of FIG. 9A. The sorting was performed based on the classification model implemented on FPGA. The classification model was implemented as an SVM, with 640 cells per class for training the model, and 160 cells per class for testing the model. Back scattering ghost motion imaging (bsGMI) and bright field ghost motion imaging (bfGMI) were used for UMAP and classification model training. The performance of the classification model was determined as: roc-auc=1.00, and as shown in chart 910 of FIG. 9B.

Sorting was performed using the trained classification model. For the validation of sorting results, the fraction of monocytes in input samples, sorted samples (cells classified as the target), and wasted samples (cells classified as the non-target cells) were compared using a flow cytometer. CD14 expression level was used for validation (CD14 high: Monocytes; CD14 low: Other cells). The performance was demonstrated by the fraction of monocytes (CD14 high cells) in the input samples being 13.7%, in the sorted samples being 71.3%, and in the waste samples being 11.6%. Charts 920, 930, 940 of FIGS. 9C-9E demonstrate these values.

Isolation of Disease Specific Cell Population from Acute Lymphoblastic Leukemia Patients

A classifier was used to perform sorting of disease specific cells from cells of patients having acute lymphoblastic leukemia (ALL). Blood samples from ALL patients of contains abnormal cells (blasts) which do not exist in samples from healthy donors. UMAP sorting was used to isolate abnormal cells in peripheral blood mononuclear cells (PBMCs) of ALL patients.

Commercially available frozen PBMCs from healthy donors and ALL patients were used. PBMCs from ALL patients and healthy donors were mixed together after staining cell membranes with different colors (PKH26 (red) for ALL, PKH67 (green) for healthy). Antibody staining was performed with CD45 for validation. GMI waveforms of input samples were measured with ghost cytometry.

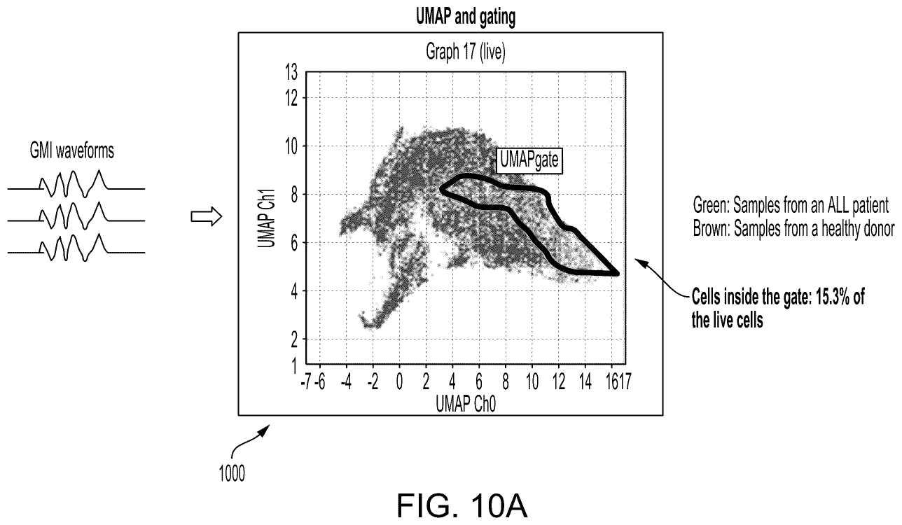

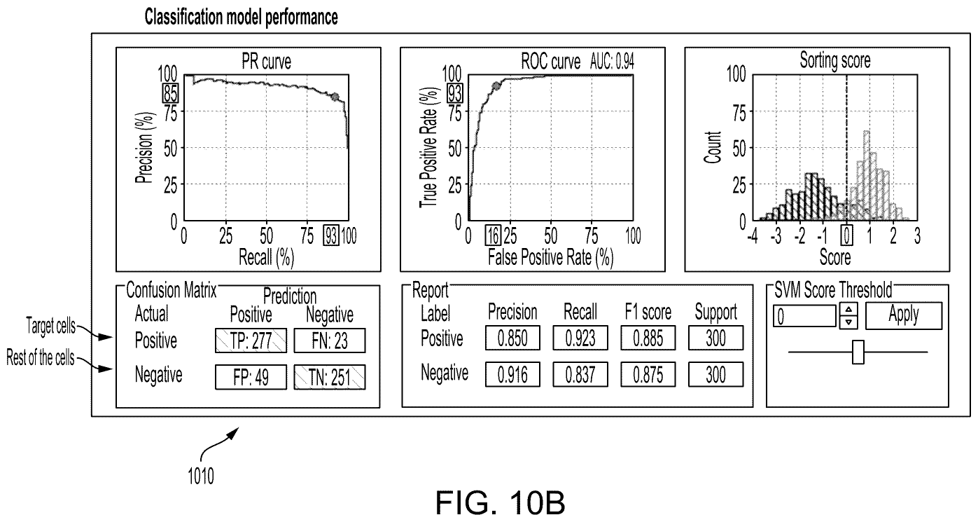

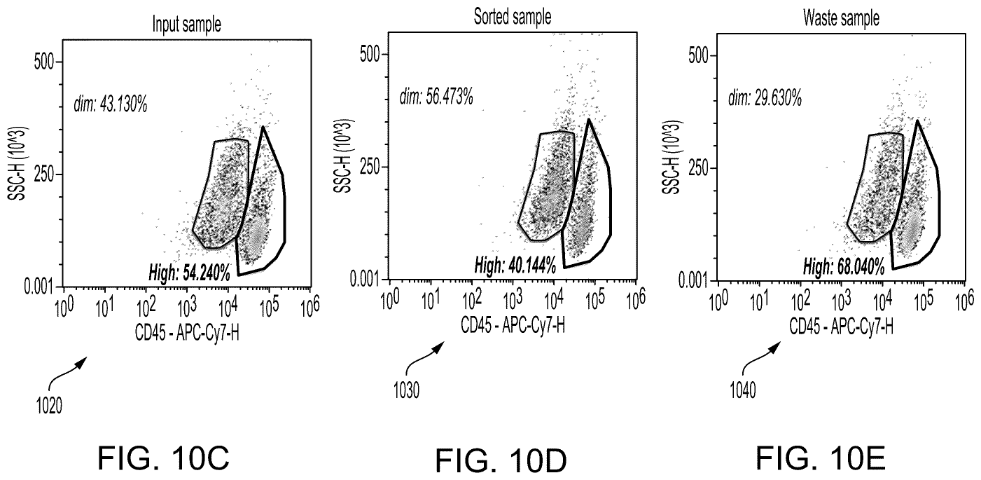

Dimensionality reduction of GMI waveforms was performed with UMAP. Target cells were defined on the basis of location in the low dimensional space. The target gate was assigned to the region where cells from patients are enriched, as depicted in chart 1000 of FIG. 10A.

Sorting was based on a classification model implemented on FPGA. The classification model was configured to classify target cells and the rest of cells in the sample. An SVM was used as the classification model. To train the model, 1200 cells per class were used, and 300 cells per class were used for testing the model. Forward scattering ghost motion imaging (fsGMI) and back scattering (bsGMI) were used for UMAP and classification model training. The performance of the classification model was determined as: roc-auc=0.94. Charts 1010 of FIG. 10B demonstrate the classification performance of the classification model.

For the validation of sorting results, the fraction of blasts in input samples, sorted samples (cells classified as the target), and wasted samples (cells classified as the non-target cells) were compared using a flow cytometer. The CD45 expression level was used for validation, where CD45 high corresponds to normal lymphocytes, and CD45 dim corresponds to blast cells (abnormal cells). The fraction of monocytes (CD45 dim cells) were found to be, in the input samples (ALL PBMC): 43.1%; in the sorted samples: 56.5%; and in the waste samples: 29.6%, as shown in charts 1020, 1030 and 1040 of FIGS. 10C, 10D and 10E.

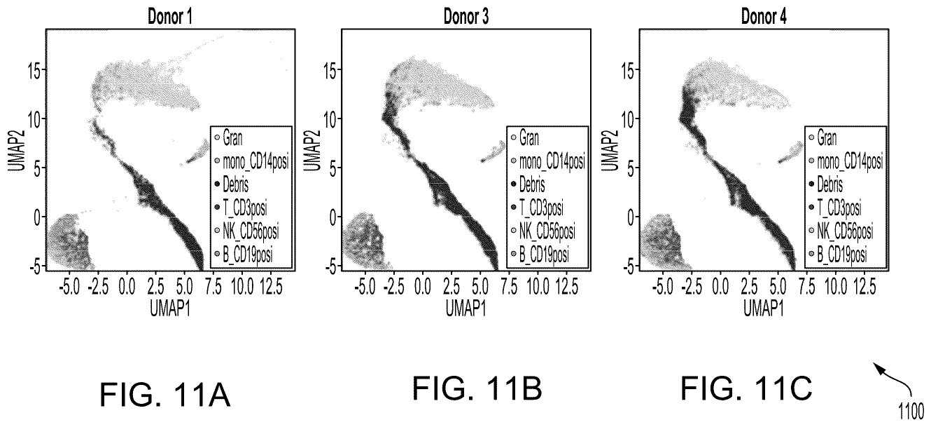

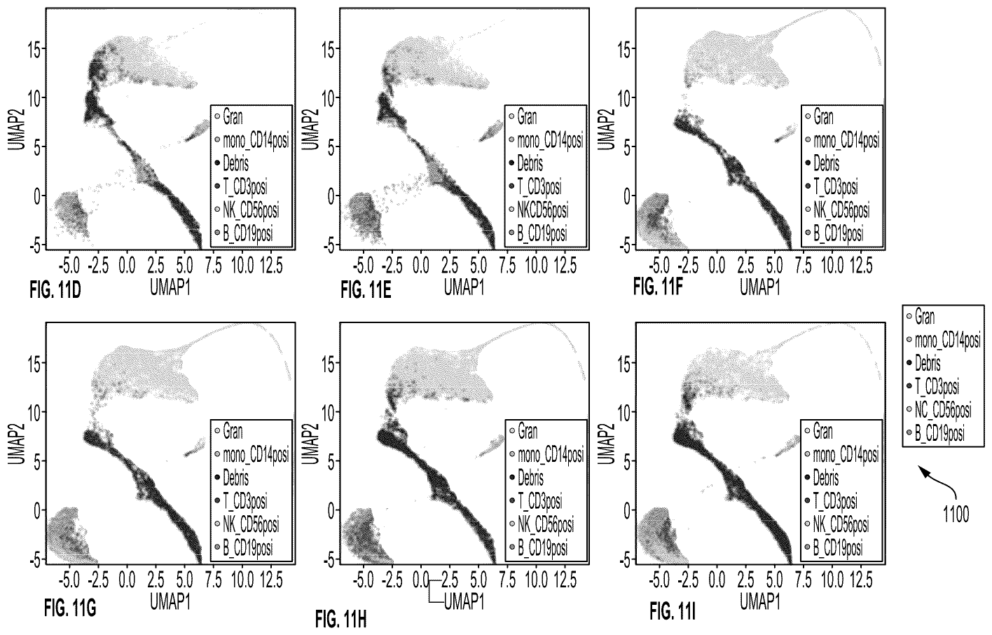

FIGS. 11A-11I depict UMAP charts 1100 from processing of features extracted (e.g., using a system configured using the variation controller 310). In particular, FIGS. 11A-11I depict UMAP charts of extracted features from a neural network. As depicted in FIGS. 11A-11I, even where the underlying data from donors have measurement variations, the variation control performed, based on feature extraction to select features that are reproducible and provide differentiation, allows for greater reproducibility and variation control for data to be used to train classification models.

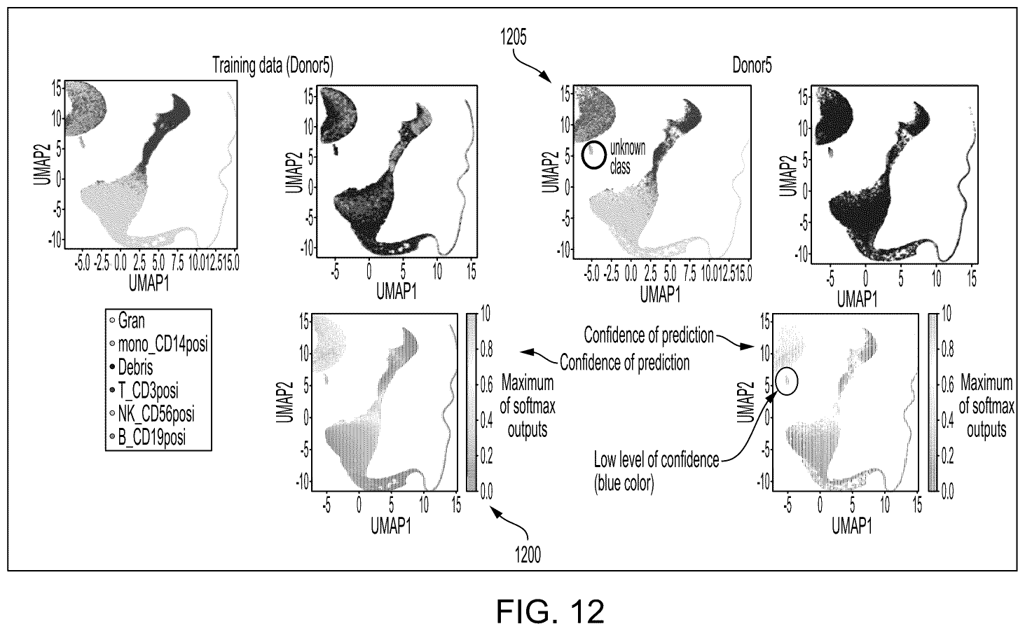

FIG. 12 depicts UMAP charts 1200 of features extracted based on training of a classification model (e.g., using the variation controller 310), and in which an unknown class 1205 is detected. For example, the use of the classification model training techniques described herein can allow for unknown classes 1205 (e.g., classes not represented in the data used to train the classification model) to be detected from sensor data for new samples, such as to be detected with confidence (e.g., as compared to incorrect detection of unknown classes that are representative of measurement variability rather than class differentiation).

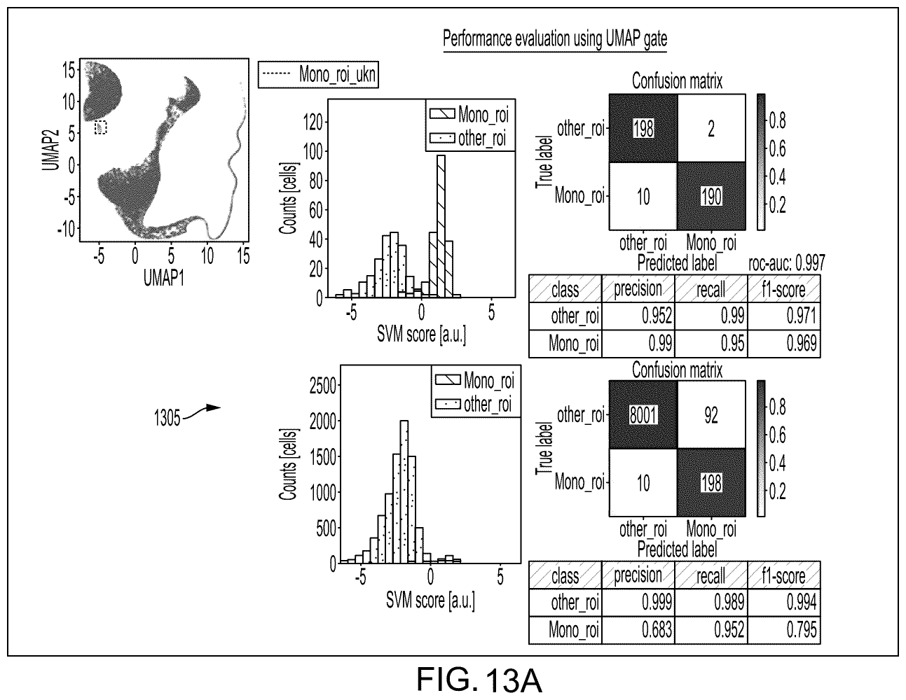

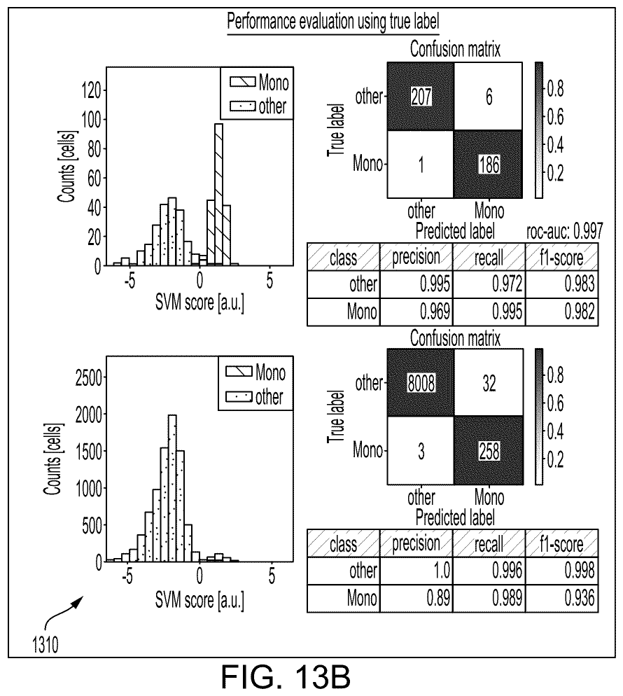

FIGS. 13A and 13B depict charts 1305, 1310 of performance of classification models in accordance with the present disclosure. As depicted in chart 1305, a classification model configured using gating based on UMAP achieved roc-auc of 0.997. As depicted in chart 1310, a classification model configured using labeling achieved roc-auc of 0.997.

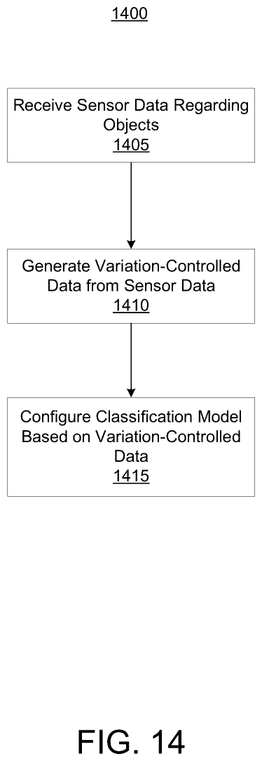

FIG. 14 depicts an example of a method 1400 for training of a machine learning model-based classifier for object classification. The method 1400 can be performed using one or more systems described herein, such as the training system 300. Various aspects of the method 1400 can be performed in end-to-end processes and/or separated or batched processes, including by the same or different devices. For example, the method 1400 can be used to perform initial training, pre-training, and/or updating of machine learning-based classification models.

At 1405, a plurality of sensor data representations of a plurality of objects can be received by one or more processors. The sensor data representations can be waveforms, such as waveforms outputted by a cytometer. The sensor data representations can be fluorescent data signals. The sensor data representations can be in the form of graphical and/or tabular data. For example, the sensor data representation can include image data. The sensor data representations can be histograms. The plurality of objects can include at least one of cellular material, nucleic acid material, biological material, or chemical material, or any combination thereof. The one or more processors can be implemented using any of various hardware devices; for example, in some implementations, a field programmable gate array (FPGA) includes the one or more processors, such as to facilitate instantaneous, real-time, and/or near real-time processing of the sensor data.

At 1410, variation-controlled data can be generated from the sensor data. The variation-controlled data can satisfy at least one of a reproducibility criterion or a differentiation criterion, such as to control for variations in the sensor data. For example, the variation-controlled data can be generated based on feature extraction from the sensor data (e.g., to detect one or more features from the sensor data). The variation-controlled data can be generated based on prediction of classifications (e.g., types) from the sensor data. In some implementations, dimensionality reduction is performed on the one or more detected features, such as to select a subset of the one or more detected features that satisfy the at least one of the reproducibility criterion or the differentiation criterion. For example, a gate can be mapped to a portion of a space (e.g., low-dimension space) in which the features are assigned responsive to the dimensionality reduction being performed, such that the gate can be used to configure a classification model and/or tag the sensor data as belonging to a classification corresponding to the feature(s) located in the gate responsive to the sensor data being mapped to the region of the space bounded by the gate.

At 1415, a classification model, such as a machine learning-based classification model, can be configured based on variation-controlled data. For example, the variation-controlled data can be provided as input to the classification model, and the classification model can be updated based on evaluation of candidate outputs generated responsive to the inputs and the variation-controlled data, such as to cause the classification model to be capable of sorting sensor data in a manner analogous to the variation-controlled data (e.g., based on features, gates, and/or classifications represented by the variation-controlled data). The classification model can be validated using a second subset (e.g., test and/or validation subset) of the sensor data representations.

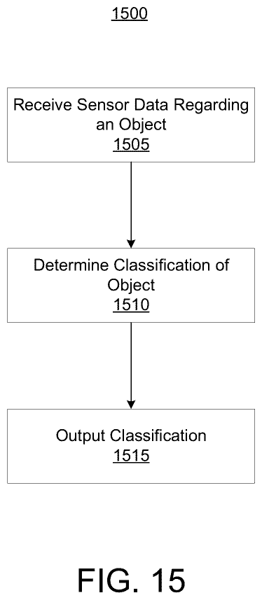

FIG. 15 depicts an example of a method 1500 for deploying a classification model for object classification. The method 1500 can be performed using various systems described herein, including but not limited to the sensor system 100 and/or classification circuit 116. The method 1500 can be performed responsive to the configuration of the classification model trained as described with respect to FIG. 12. The method 1500 can be performed by hardware of the sensor system 100 (e.g., by a circuit of the sensor 108) and/or remote from the sensor system 100. The method 1500 can be performed in synchronous/real-time operations or can be performed asynchronously. For example, the method 1500 can be performed responsive to receiving outputs from the sensor 108 or can be performed on stored outputs from the sensor 108. In particular, the method 1500 can be performed on batches of stored outputs from the sensor 108.

At 1505, sensor data regarding an object can be received. The sensor data can be received from a flow cytometer, a photosensor/photodetector, or an image capture device. The sensor data can be received by being retrieved from a data source remote from the flow cytometer, photosensor/photodetector, or image capture device. The sensor data can include data structures and/or electrical signals representative of waveforms, such as GMI waveforms, image data, fluorescence data, or various combinations thereof.

At 1510, the sensor data can be applied as input to a classification model, such as a machine learning-based classification model. The classification model can include, for example, an SVM, a decision tree, or a logistic regression function. The classification model can be configured based on feature data from at least a first example of object data and a second example of object data, the second example associated with at least one of a different time of detection or a different subject than the first example. For example, the differences in time of detection and/or subjects that the examples of data are associated with can allow for the classification model to be configured to account for such differences (e.g., variations). The different time of detection among the first example and the second example can be determined by a timer, for example. The different subjects can be different samples for classification, for example.

In some implementations, the feature data that the classification model is configured with satisfies at least one of a reproducibility criterion or a differentiation criterion, which can allow for the classification model to effectively control for variation amongst the examples of object data while also clearly differentiation amongst various classifications (as well as to detect unknown/new classifications for the sensor data that may not be represented in the examples of object data).

At 1515, the classification can be outputted. For example, the classification can be stored in a data structure, which can also include at least one of the sensor data or an identifier of the object. The data structure can be transmitted remotely, e.g., to a remote device, a cloud computing network, an offsite data storage center, etc. The classification can be presented by a user interface (e.g., in graphical or tabular form, via one or more display screens).

### Exemplary Computer Implementations

The present disclosure provides computer systems that are programmed to implement methods and systems of the disclosure. FIG. 17 shows a computer system 1301 that includes a central processing unit (CPU, also “processor” and “computer processor” herein) 1305, which can be a single core or multi core processor, or a plurality of processors for parallel processing. The computer system 1301 can include or be in communication with an electronic display 1335 that comprises a user interface (UI) 1340 for providing, for example, information to a user. Examples of user interfaces include, without limitation, a graphical user interface (GUI) and web-based user interface.

The computer system 1301 also includes memory or memory location 1310 (e.g., random-access memory, read-only memory, flash memory), electronic storage unit 1315 (e.g., hard disk), communication interface 1320 (e.g., network adapter) for communicating with one or more other systems, and peripheral devices 1325, such as cache, other memory, data storage and/or electronic display adapters. The memory 1310, storage unit 1315, interface 1320 and peripheral devices 1325 are in communication with the CPU 1305 through a communication bus (solid lines), such as a motherboard. The storage unit 1315 can be a data storage unit (or data repository) for storing data. The computer system 1301 can be operatively coupled to a computer network (“network”) 1330 with the aid of the communication interface 1320. The network 1330 can be the Internet, an internet and/or extranet, or an intranet and/or extranet that is in communication with the Internet. The network 1330 in some cases is a telecommunication and/or data network. The network 1330 can include one or more computer servers, which can enable distributed computing, such as cloud computing. The network 1330, in some cases with the aid of the computer system 1301, can implement a peer-to-peer network, which may enable devices coupled to the computer system 1301 to function as a client or a server.

The CPU 1305 can execute a sequence of machine-readable instructions, which can be embodied in a program or software. The instructions may be stored in a memory location, such as the memory 1310. The instructions can be directed to the CPU 1305, which can subsequently program or otherwise configure the CPU 1305 to implement methods of the present disclosure. Examples of operations performed by the CPU 1305 can include fetch, decode, execute, and writeback.

The CPU 1305 can be part of a circuit, such as an integrated circuit. One or more other components of the system 1301 can be included in the circuit. In some cases, the circuit is an application specific integrated circuit (ASIC).

The storage unit 1315 can store files, such as drivers, libraries and saved programs. The storage unit 1315 can store user data, e.g., user preferences and user programs. The computer system 1301 in some cases can include one or more additional data storage units that are external to the computer system 1301, such as located on a remote server that is in communication with the computer system 1301 through an intranet or the Internet.

The computer system 1301 can communicate with one or more remote computer systems through the network 1330. For instance, the computer system 1301 can communicate with a remote computer system of a user. Examples of remote computer systems include personal computers (e.g., portable PC), slate or tablet PC's (e.g., Apple® iPad, Samsung® Galaxy Tab), telephones, smart phones (e.g., Apple® iphone, Android-enabled device, Blackberry®), or personal digital assistants. The user can access the computer system 1301 via the network 1330.

Methods as described herein (such as one or more methods for particle analysis, image-free optical methods, or methods for identifying one or more target cells from a plurality of cells, as described herein) can be implemented by way of machine executable code (e.g., where the machine is at least one computer processor or at least one microprocessor) stored on an electronic storage location of the computer system 1301, such as, for example, on the memory 1310 or electronic storage unit 1315. The machine executable or machine readable code can be provided in the form of software.

During use, the code can be executed by the processor 1305. In some cases, the code can be retrieved from the storage unit 1315 and stored on the memory 1310 for ready access by the processor 1305. In some situations, the electronic storage unit 1315 can be precluded, and machine-executable instructions are stored on memory 1310.

The code can be pre-compiled and configured for use with a machine having a processer adapted to execute the code or can be compiled during runtime. The code can be supplied in a programming language that can be selected to enable the code to execute in a pre-compiled or as-compiled fashion.

### Definitions

Having described certain illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

Various numerical values herein are provided for reference purposes only. Unless otherwise indicated, all numbers expressing quantities of properties, parameters, conditions, and so forth, used in the specification and claims are to be understood as being modified in all instances by the term “about” or “approximately.” Accordingly, unless indicated to the contrary, the numerical parameters set forth in the following specification are approximations. Any numerical parameter should at least be construed in light of the number of reported significant digits and by applying ordinary rounding techniques. The term “about” or “approximately” when used before a numerical designation, e.g., a quantity and/or an amount including ranges, indicates approximations which may vary by +10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The term “coupled” and variations thereof includes the joining of two members directly or indirectly to one another. Such joining may be stationary or moveable. Such joining may be achieved with the two members coupled directly with or to each other, or with the two members coupled with each other using an intervening member. Such coupling may be mechanical, electrical, or fluidic.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions. Any processing may be carried out by one or more computers, microcomputers, controllers, microcontrollers, processors and/or microprocessors, that may be provided centrally or in a distributed manner, where the processing can be carried out individually or collectively by a plurality of the computers, microcomputers, controllers, microcontrollers, processors and/or microprocessors.

Although the figures show a specific order of method steps, the order of the steps may differ from what is depicted. Also two or more steps may be performed concurrently or with partial concurrence. Such variation will depend on the software and hardware systems chosen and on design considerations. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular structure or portion thereof. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

References to “or” may be construed as inclusive so that any terms described using “or” may indicate any of a single, more than one, and all of the described terms. References to at least one conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in values of parameters or variations in arrangements can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The scope of the systems and methods described herein is indicated by the appended claims, rather than the foregoing description, and variations that come within the meaning and range of equivalency of the claims are embraced therein.

What is claimed is:

1. A system, comprising:
one or more processors configured to:
retrieve sensor data regarding an object, wherein the object comprises at least one of at least one of cellular material, nucleic acid material, biological material, or chemical material; and
apply the sensor data as input to a classifier to cause the classifier to determine a classification of the object, the classifier configured based on feature data from at least a first example of object data and a second example of object data, the second example associated with at least one of a different time of detection or a different subject than the first example; and
output the classification of the object.

2. The system of claim 1, wherein the classifier comprises a machine learning model configured based on a gate selected based on dimensionality reduction of the feature data.

3. The system of claim 1, wherein the classifier comprises a machine learning model configured based on object types determined for the first example of object data and the second example of object data.

4. The system of claim 1, wherein the one or more processors are configured to detect the classification to include an object type of the object.

5. The system of claim 1, wherein the sensor data, the first example of object data, and the second example of object data each respectively comprise a time-series electrical signal representative of an electromagnetic wave detected regarding corresponding objects.

6. The system of claim 1, wherein the feature data comprises at least one of (i) a reproducibility criterion amongst the first example of object data and the second example of object data or (ii) a differentiation criterion amongst the first example of object data and the second example of object data.

7. The system of claim 1, wherein the classifier comprises at least one of a support vector machine, a logistic regression function, or a decision tree.

8. The system of claim 1, wherein the one or more processors are configured to update the classifier based on the sensor data and the classification.

9. The system of claim 1, wherein a field programmable gate array (FPGA) comprises the one or more processors, the FPGA configured to include one or more parameters representative of the classifier.

10. The system of claim 1, wherein
a flow cytometer comprises the one or more processors and further comprises a sensor to detect the sensor data regarding the object.

11. A system, comprising:
a flow cytometer configured to direct a fluid flow comprising an object through a field of view of a photosensor and cause the photosensor to detect sensor data regarding the object; and
one or more processors to apply the sensor data as input to a classifier to cause the classifier to determine a classification of the object, the classifier configured based on feature data from at least a first example of object data and a second example of object data, the second example associated with at least one of a different time of detection or a different subject than the first example.

12. The system of claim 11, wherein the classifier comprises a machine learning model configured based on dimensionality reduction of the feature data, the machine learning model comprising at least one of a support vector machine, a logistic regression function, or a decision tree.

13. The system of claim 11, wherein the classifier comprises a machine learning model configured based on object types predicted by a neural network for the first example of object data and the second example of object data.

14. The system of claim 11, wherein the sensor data, the first example of object data, and the second example of object data each respectively comprise a time-series electrical signal representative of an electromagnetic wave detected regarding corresponding objects.

15. The system of claim 11, wherein the feature data comprises at least one of (i) a reproducibility criterion amongst the first example of object data and the second example of object data or (ii) a differentiation criterion amongst the first example of object data and the second example of object data.

16. The system of claim 11, wherein a field programmable gate array (FPGA) comprises the one or more processors, the FPGA configured to receive the sensor data from a flow cytometer through which the object is flowed.

17. A method, comprising:
receiving, by one or more processors, a plurality of waveforms, each waveform representative of an object type of a corresponding object of a plurality of objects, a first waveform of the plurality of waveforms associated with at least one of a different time of detection or a different subject than a second waveform of the plurality of waveforms, wherein the plurality objects comprise at least one of cellular material from one or more cells, nucleic acid material, biological material or chemical material;
detecting, by the one or more processors, one or more features based on the plurality of waveforms, the one or more features satisfying at least one of a reproducibility criterion or a differentiation criterion amongst the plurality of waveforms; and
updating, by the one or more processors, a machine learning model based on the detected one or more features to configure the machine learning model as a classifier for detection of object types.

18. The method of claim 17, wherein detecting the one or more features comprises applying the plurality of waveforms as input to a dimensionality reduction operation.

19. The method of claim 17, wherein detecting the one or more features comprises applying the plurality of waveforms as input to a neural network trained to predict the object types of the objects of the plurality of waveforms.

20. The method of claim 17, wherein the differentiation criterion corresponds to a distance between (i) a first subset of the plurality of waveforms corresponding to a first object type of a plurality of object types and (ii) a second subset of the plurality of waveforms corresponding to a second object type of the plurality of object types.
